(19) United States
(12) Patent Application Publication
(10) Pub. No.: US 2023/0026448 A1
(43) Pub. Date: Jan. 26, 2023

(54) TONER, METHOD OF MANUFACTURING TONER, TONER STORAGE UNIT, IMAGE FORMING APPARATUS, AND METHOD OF FORMING IMAGE

(71) Applicants: Hiroshi YAMASHITA, Shizuoka (JP); Kazuoki Fuwa, Shizuoka (JP); Junichi Watanabe, Shizuoka (JP)

(72) Inventors: Hiroshi YAMASHITA, Shizuoka (JP); Kazuoki Fuwa, Shizuoka (JP); Junichi Watanabe, Shizuoka (JP)

(73) Assignee: Ricoh Company, Ltd., Tokyo (JP)

(21) Appl. No.: 17/811,692

(22) Filed: Jul. 11, 2022

(30) Foreign Application Priority Data
Jul. 14, 2021 (JP) 2021-116496

(51) Int. Cl. G03G 9/093; G03G 9/08; G03G 15/08

(52) U.S. Cl. CPC G03G 9/09371; G03G 9/0819; G03G 9/09392; G03G 15/0865

(57) ABSTRACT

A toner has excellent low temperature fixing property, heat resistant preservability, and stable image quality. The toner contains a core including a crystalline polyester, and a shell formed on a surface of the core. An aspect ratio of the crystalline polyester in the toner is within a range from 1 to 3, and an average length of a longitudinal diameter of the crystalline polyester is within a range from 10 nm to 500 nm.

### CROSS-REFERENCE TO RELATED APPLICATION

The present application claims priority under 35 U.S.C. § 119 to Japanese Patent Application No. 2021-116496, filed Jul. 14, 2021, the contents of which are incorporated herein by reference in their entirety.

### BACKGROUND OF THE INVENTION

### 1. Field of the Invention

The disclosures herein relate to a toner, a method of manufacturing toner, a toner storage unit, an image forming apparatus, and a method of forming an image.

### 2. Description of the Related Art

In recent years, toners are required to have small particle size and high temperature offset resistance for high quality output images, low temperature fusing performance for energy saving, and thermal shelf life to withstand high temperature and high humidity during storage and transportation after manufacturing. In particular, since the power consumption at the time of fixing accounts for most of the power consumption in the image forming step, the improvement of the low temperature fixing property is extremely important.

Conventionally, toners manufactured by a kneading and pulverization method have been used. However, the toners manufactured by the kneading and pulverization method have problems such as difficulty in reducing the particle size, irregular shape, and wide particle size distribution (broadness). Therefore, there have been problems such as in insufficient quality of output image and high fixing energy.

In addition, when wax (mold-release agent) is added to improve fixing property, a toner produced by a kneading and pulverization method is likely to be broken at the interface of the wax during pulverizing, so that the wax is more likely to be present on the toner surface. Therefore, while the mold releasing effect is obtained, toner tends to adhere (filming) to a carrier, a photoconductor, and a blade, and there has been a problem that the overall performance is not satisfactory.

Therefore, in order to overcome the problem of the kneading and pulverization method, a method of manufacturing toner by the polymerization method has been proposed. Patent Document 1 discloses a toner of a core shell structure having a core containing a crystalline polyester resin and a shell containing amorphous resin (See, for example, Japanese unexamined patent application publication No. 2017-32660).

### SUMMARY OF THE INVENTION

### Problem to be Solved by the Invention

However, the crystalline polyester resin contained in the core is heated in the manufacturing step of the toner to the melting point of the crystalline resin or higher, partially dissolves with the amorphous resin contained in the shell, and crystals are grown in the toner to form a needle or plate. The precipitated resin component enters the shell and protrudes into the toner surface. Accordingly, the toner of the core shell structure tends to become contaminated with the equipment, to have reduced fluidity and charging properties of the toner itself, and to have reduced heat resistant preservability and image quality.

The object of the present invention is to provide a toner having excellent low temperature fixing property, heat resistant preservability, and stable image quality.

### Means for Solving the Problem

In order to solve the above-described problems, one aspect of the present invention is a toner containing a core including a crystalline polyester; and a shell formed on a surface of the core, wherein an aspect ratio of the crystalline polyester in the toner is within a range from 1 to 3, and wherein an average length of a longitudinal diameter of the crystalline polyester is within a range from 10 nm to 500 nm.

### Effect of the Invention

According to an aspect of the invention, the present invention can provide a toner having excellent low temperature fixing property, heat resistant preservability, and stable image quality.

### BRIEF DESCRIPTION OF THE DRAWINGS

FIG. 1 is an enlarged schematic view of crystalline polyester resin particles;

FIG. 2 is a schematic view illustrating an example of an image forming apparatus;

FIG. 3 is a schematic view illustrating another example of an image forming apparatus;

FIG. 4 is a schematic view illustrating another example of an image forming apparatus;

FIG. 5 is a partially enlarged view of FIG. 4; and

FIG. 6 is a schematic view illustrating an example of a process cartridge.

### DESCRIPTION OF THE PREFERRED EMBODIMENTS

Hereinafter, embodiments of the present invention will be described.

<Toner>

The toner of the present embodiment has a core containing a crystalline polyester and a shell formed on the surface of the core.

As used herein, the core represents the core of the toner. The shell represents an outer shell covering at least a portion of the core.

The toner of the present embodiment contains at least a crystalline polyester resin and an amorphous polyester resin as a binding resin. The toner of the present embodiment may also contain a binding resin other than a crystalline polyester resin and an amorphous polyester resin. In addition, the toner of the present embodiment contains other components such as a coloring agent, a mold release agent, and the like, if necessary.

In the toner of the present embodiment, the core includes at least a crystalline polyester (crystalline polyester resin). The shell preferably includes an amorphous polyester (amorphous polyester resin) and does not include a crystalline polyester resin.

The crystalline polyester resins that may be contained in the core are obtained from polyvalent alcohols and polycarboxylic acids such as polycarboxylic acids, polycarboxylic anhydrides, polycarboxylic acid esters, and derivatives thereof.

In the present embodiment, the crystalline polyester resin refers to a polycarboxylic acid or its derivative obtained from the above-described polyester resin. The polyester resin modified by crosslinking and/or elongation of a prepolymer, such as a prepolymer, does not belong to a crystalline polyester resin.

The polyvalent alcohols are not particularly limited and may be appropriately selected according to a purpose. Examples of the polyvalent alcohols include diols and trivalent or higher alcohols.

Examples of diols include saturated aliphatic diols and the like. The saturated aliphatic diols include linear chain saturated aliphatic diols and branched saturated aliphatic diols. Of these, linear chain saturated aliphatic diols are preferred, and linear chain saturated aliphatic diols having 2 to 12 carbons are more preferred.

If the saturated aliphatic diol is branched, the crystallinity of the crystalline polyester resin may be reduced and the melting point may be reduced. Also, if the carbon number of the saturated aliphatic diol exceeds 12, practical materials are difficult to obtain.

Saturated aliphatic diols may include, for example, ethylene glycol, 1,3-prophane diol, 1,4-buthane diol, 1,5 pentane diol, 1,6-hexane diol, 1,7-heptane diol, 1,8-octane diol, 1,9-nonane diol, 1,10-decane diol, 1,11-undecane diol, 1,12-dodecane diol, 1,13-tridecane diol, 1,14-tetradecane diol, 1,18-octadecane diol, 1-14-eicosanedecane diol, and the like.

Among them, ethylene glycol, 1,4-buthane diol, 1,6-hexane diol, 1,8-octane diol, 1,9-nonane diol, 1,10-decane diol, and 1,12-dodecane diol are preferable in that the crystallinity of the crystalline polyester resin is high and the sharp melting property is excellent.

Trivalent alcohols or higher may include, for example, glycerin, trimethylolethane, trimethylolpropane, pentaerythritol, and the like. The above-described alcohols may be used singly, or a combination of two or more alcohols may be used.

The polyvalent carboxylic acid is not particularly limited, and can be appropriately selected according to a purpose. For example, suitable polyvalent carboxylic acids may include divalent carboxylic acid and trivalent or higher carboxylic acid.

Suitable divalent carboxylic acids may include, for example, saturated aliphatic dicarboxylic acids, such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, or 1,18-octadecanedicarboxylic acid; and an aromatic dicarboxylic acid, such as phthalic acid, isophthalic acid, terephthalic acid, naphthalene-2,6-dicarboxylic acid, or malonic acid, mesaconic acid.

Furthermore, anhydrides thereof, or lower (1 to 3 carbon atoms) alkyl esters thereof may be included.

Suitable trivalent or higher carboxylic acids may include, for example, 1,2,4-benzenetricarboxylic acid, 1,2,5-benzenetricarboxylic acid, 1,2,4-naphthalenetricarboxylic acid, and the like; and anhydrides thereof, lower (1-3 carbon atoms) alkyl esters thereof, or the like. The above-described carboxylic acids may be used singly, or a combination of two or more carboxylic acids may be used.

The crystalline polyester resin is preferably composed of linear saturated aliphatic dicarboxylic acid of 4 to 12 carbon atoms and linear saturated aliphatic diol of 2 to 12 carbon atoms. According to the above-described composition, the crystalline polyester resin has high crystallinity and is excellent in the sharp melting property. Thus, the toner exhibits an excellent low temperature fixing property.

Moreover, a method of controlling the crystallinity and a softening point of the crystalline polyester resin includes designing, using, and the like non-linear polyester or the like. The non-linear polyester may be obtained by subjecting condensation polymerization adding trivalent or higher alcohols such as glycerin to an alcohol component, and adding trivalent or higher carboxylic acid such as an anhydrous trimellitic acid to an acid component at the time of synthesis of the polyester.

In the toner of the present embodiment, the molecular structure of the crystalline polyester resin may be determined through nuclear magnetic resonance (NMR) of a liquid or solid sample, X-ray diffraction, GC/MS (gas chromatography mass spectrometry), LC/MS (liquid chromatography mass spectrometry), IR (infrared) spectroscopy, or the like.

Alternatively, the molecular structure may be determined based on the infrared absorption spectrum in which an absorption based on an out-of-plane bending vibration (δCH) of an olefin is observed at 965±10 cm⁻¹ or at 990±10 cm⁻¹, as an example.

The molecular weight of the crystalline polyester resin is taking into account that a resin with a low molecular weight has a sharp molecular weight distribution and is excellent in the low temperature fixing property, but as the amount of the low molecular weight resins increase the heat resistant preservability degrades.

The molecular weight of the crystalline polyester resin is estimated from a molecular weight distribution diagram in which the molecular weight distribution of a soluble component of ortho-dichlorobenzene, as measured using gel permeation chromatography (GPC), is plotted with log(M) on the horizontal axis and the mass % on the vertical axis. A peak position in the molecular weight diagram is assumed to be within a range from 3.5 to 4.0, and a half-value width of the peak is assumed to be less than or equal to 1.5.

A weight-average molecular weight (Mw) of the crystalline polyester is preferably within a range from 3,000 to 30,000, and more preferably is within a range from 5000 to 15000. A number-average molecular weight (Mn) of the crystalline polyester is preferably within a range from 1,000 to 10,000, and more preferably is within a range from 2,000 to 10,000. A ratio of the weight-average molecular weight (Mw) to the number-average molecular weight (Mn) preferably is within a range from 1 to 10, and more preferably is within a range from 1 to 5.

An acid number of the crystalline polyester resin is preferably 5 mgKOH/g or more to achieve the target low temperature fixing property from a viewpoint of an affinity between a paper and the resin, and more preferably 10 mgKOH/g or more to prepare fine particles using a phase inversion emulsification method. On the other hand, the acid number of the crystalline polyester resin is preferably 45 mgKOH/g or less to enhance hot off-set property.

A hydroxyl number of the crystalline polyester resin preferably is within a range from 0 mgKOH/g to 50 mgKOH/g, and more preferably is within a range from 5 mgKOH/g to 50 mgKOH/g to achieve the target low temperature fixing property and achieve an excellent charging characteristic.

The core constituting the toner of the present embodiment may contain a binding resin other than the crystalline polyester resin described above.

Other binding resins other than the crystalline polyester resin described below may include, but are not limited to, known binding resins such as, for example, the amorphous polyester resin, silicone resin, styrene/acrylic resin, styrene resin, acrylic resin, epoxy resin, diene-based resin, phenolic resin, terpene resin, terpene phenol resin, coumarin resin, amideimide resin, butyral resin, urethane resin, ethylene/vinyl acetate, polyethylene terephthalate, and the like.

Among them, the bonding resin used in the method of manufacturing the toner according to the present embodiment includes at least an amorphous polyester resin having sufficient flexibility even when the amorphous polyester resin becomes low molecular weight, in that the bonding resin can be sharply molten at the time of fixing, and functions as a binding resin that smooths the surface of an image. In addition, other resins may be used in combination with such an amorphous polyester resin.

Examples of amorphous polyester resins that may be contained in cores and shells include polyester resins (prepolymers) having urethane bonds and/or urea bonds and unmodified polyester resins that do not have urethane bonds and/or urea bonds.

The amorphous polyester resin preferably includes a polyester resin having a urethane bond and a urea bond. By including the polyester resin having the urethane bond and the urea bond, the heat resistant preservability by the cross-linking can be secured, and flexibility in the design of the low temperature fixing can be increased.

An unmodified polyester resin is a polyester resin obtained using polyvalent alcohol; and polyvalent carboxylic acid or derivative thereof such as polyvalent carboxylic acid anhydride or polyvalent carboxylic acid ester, and is not modified by an isocyanate compound or the like.

Examples of polyvalent alcohols include diols and the like.

Suitable diols may include, for example, alkylene (2 to 3 carbon atoms) oxide (average addition molar number: 1 to 10) adduct of bisphenol A, such as polyoxypropylene (2.2)-2,2-bis (4-hydroxyphenyl) propane, or polyoxyethylene (2.2)-2,2-bis (4-hydroxyphenyl) propane; ethylene glycol, propylene glycol; hydrogenated bisphenol A, alkylene (2 to 3 carbon atoms) oxide (average addition molar number: 1 to 10) adduct of the hydrogenated bisphenol A, and the like.

The above-described diols may be used singly, or a combination of two or more diols may be used.

Examples of the polycarboxylic acid include dicarboxylic acids.

Suitable dicarboxylic acids may include, for example, adipic acid, phthalic acid, isophthalic acid, terephthalic acid, fumaric acid, maleic acid, dodecanedioic acid; succinic acid substituted with an alkyl group of 1 to 20 carbon atoms or an alkenyl group of 2 to 20 carbon atoms, such as dodecenylsuccinic acid or octylsuccinic acid, and the like. In particular, from a point of the heat resistant preservability, the terephthalic acid is preferably included at 50 mol % or more.

Further, the carboxylic acid components may also contain a modified refined rosin. The modified refined rosin is preferably acrylic acid, fumaric acid, and maleic acid.

The above-described dicarboxylic acids may be used singly, or a combination of two or more dicarboxylic acids may be used.

Moreover, suitable unmodified polyester resins may include trivalent or higher carboxylic acids and/or trivalent or higher alcohols at a terminal of the resin chain, to control the acid number and the hydroxyl number.

Trivalent or higher carboxylic acids may include, for example, trimellitic acid, pyromellitic acid, or acid anhydrides thereof, or the like.

Trivalent or higher alcohols may include, for example, glycerin, pentaerythritol, trimethylolpropane, or the like.

A molecular weight of the unmodified polyester resin is not particularly limited, and can be appropriately selected according to a purpose. However, when the molecular weight of the unmodified polyester resin is too small, the toner may have poor heat resistant preservability and durability against stresses such as agitation in the developing device. When the molecular weight is too large, viscoelasticity of the toner at the time of melting becomes high, and the low temperature fixing property may be degraded.

If the unmodified polyester resin having a molecular weight of 600 or less is too large, the toner may have poor heat resistant preservability and durability against stresses such as agitation in the developing device. If the unmodified polyester resin having a molecular weight of 600 or less is too small, the low temperature fixing property may be degraded.

Thus, in the GPC, the weight-average molecular weight (Mw) of the unmodified polyester resin is preferably within a range from 3,000 to 10,000. The number-average molecular weight (Mn) is preferably within a range from 1,000 to 4,000. The ratio of the weight-average molecular weight (Mw) to the number-average molecular weight (Mn) preferably is within a range from 1.0 to 4.0.

In addition, the components having a molecular weight of 600 or less of THF soluble portion are preferably within a range from 2 wt % to 10 wt %, and the unmodified polyester resin may be refined by using methanol extraction to remove the component having molecular weight of 600 or less.

The weight average molecular weight (Mw) of the unmodified polyester resin is preferably within a range from 4,000 to 7,000. The number average molecular weight (Mn) of the unmodified polyester resin is preferably within a range from 1,500 to 3,000. The Mw/Mn of the unmodified polyester resin is preferably within a range from 1.0 to 3.5.

The acid number of the unmodified polyester resin is not particularly limited, and can be appropriately selected according to a purpose. The acid number is preferably within a range from 1 mgKOH/g to 50 mgKOH/g and more preferably within a range from 5 mgKOH/g to 30 mg KOH/g.

When the acid number of the unmodified polyester resin is 1 mgKOH/g or more, the toner is negatively charged easily, the affinity between a paper and the toner is good at the time of fixing to the paper, and the low temperature fixing property can be improved. Moreover, when the acid number is 50 mgKOH/g or less, reductions in the charge stability, particularly in the charge stability with respect to environmental changes, can be effectively avoided.

In the toner according to the present embodiment, the acid value of the resin constituting the shell is preferably greater than the acid value of the resin constituting the core excluding the crystalline polyester.

The hydroxyl number of the unmodified polyester resin is not particularly limited, and can be appropriately selected according to a purpose. The hydroxyl number is preferably 5 mg KOH/g or more.

The glass transition temperature (hereinafter, it may be abbreviated as Tg) of the unmodified polyester resin is preferably within a range from 40° C. to 80° C., and more preferably is within a range from 50° C. to 70° C.

When the glass transition temperature Tg is 40° C. or higher, it can effectively prevent the problems of poor heat resistant preservability and durability of the toner against stresses such as agitation in the developing machine, as well as deterioration of filming resistance. Moreover, when the glass transition temperature Tg is 80° C. or less, it is possible to obtain sufficient deformation of the toner according to the heating and pressuring at the time of the fixing of the toner, and sufficient low temperature fixing property can be obtained.

The prepolymer of the present embodiment (polyester resin having a urethane bond and/or a urea bond) is not particularly limited, and can be appropriately selected according to a purpose. Components of the prepolymer preferably contain a diol component and a crosslinking component, and more preferably a polyester resin containing a dicarboxylic acid component may be used.

Aliphatic diols having 3 to 10 carbons include, for example, 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol, 1,12-dodecanediol, and the like.

The diol component of the polyester resin preferably has an odd number of carbon atoms in a part of a main chain, and has an alkyl group in a side chain. The diol preferably has a structure expressed by the following general formula (1), similar to the aliphatic diol of 3 to 10 carbon atoms,

HO—(CR¹R²)ₙ—OH (1)

In the above formula, each of R¹ and R² independently represents a hydrogen atom or an alkyl group of 1 to 3 carbon atoms, n represents an odd number within a range from 3 to 9, and among the n recurring units R¹ and R² may be the same or different, respectively.

As noted above, the crosslinking component of the polyester resin contains trivalent or higher aliphatic alcohol. The trivalent or tetravalent aliphatic alcohol is preferably contained in the crosslinking component of the polyester resin from the viewpoint of a gloss and an image density of a fixed image. The crosslinking component may be only trivalent or higher aliphatic alcohols. Suitable trivalent or higher aliphatic alcohols may include glycerin, trimethylolethane, trimethylolpropane, pentaerythritol, sorbitol, dipentaerythritol, and the like.

The polyester resin also has a urethane bond and/or a urea bond in order to improve adhesion to a recording medium such as paper. This allows the urethane bond or the urea bond to behave like a pseudo-crosslinked point, enhances the rubber-like property of the polyester resin, and provides better heat resistant preservability of the toner.

Here, diol components and dicarboxylic acid components used for polyester resins (prepolymers) having urethane and/or urea bonds and polyester resins that does not have urethane and/or urea bonds will be described in the followings.

The diol component is not particularly limited and may be selected as appropriate depending on the purpose.

Suitable diol components may include, for example, aliphatic diols such as ethylene glycol, 1,2-propylene glycol, 1,3-propylene glycol, 1,4-butane diol, 2-methyl-1,3-propane diol, 1,5-penta diol, 3-methyl-1,5-pentane diol, 1,6-hexane diol, 1,8-octane diol, 1,10-decane diol, or 1,12-dodecane diol; diols having an oxyalkylene group such as diethylene glycol, triethylene glycol, dipropylene glycol, polyethylene glycol, polypropylene glycol, or polytetramethylene glycol; alicyclic diols such as 1,4-cyclohexane dimethanol, or hydrogenated bisphenol A; alicyclic diol to which alkylene oxide such as ethylene oxide, propylene oxide, or butylene oxide is added; bisphenol compound such as bisphenol A, bisphenol F, or bisphenol S; alkylene oxide adduct of bisphenol compound such as a bisphenol product to which alkylene oxide such as ethylene oxide, propylene oxide, or butylene oxide is added; and the like.

Among them, aliphatic diol of 4 to 12 carbon atoms is preferable. The above-described diol components may be used singly, or a combination of two or more diol components may be used.

The dicarboxylic acid component is not particularly limited and may be selected according to the purpose, for example, aliphatic dicarboxylic acid, aromatic dicarboxylic acid, and the like. These anhydrides, lower (1 to 3 carbon atoms) alkyl esters, halides may also be used.

Examples of aliphatic dicarboxylic acids include succinic acid, adipic acid, sebacic acid, dodecanoic acid, maleic acid, fumaric acid, and the like. Examples of aromatic dicarboxylic acids include phthalic acid, isophthalic acid, terephthalic acid, naphthalenedicarboxylic acid, and the like. Among these, aliphatic dicarboxylic acids having 4 to 12 carbons are preferred. The above-described dicarboxylic acids may be used singly or a combination of two or more dicarboxylic acids may be used.

Trivalent or higher aliphatic alcohols are not particularly limited, and can be appropriately selected according to a purpose. Suitable trivalent or higher aliphatic alcohols include glycerine, trimethylolethane, trimethylolpropane, pentaerythritol, sorbitol, dipentaerythritol, and the like.

Of these, trivalent or tetravalent aliphatic alcohols are preferably used. These trivalent or higher aliphatic alcohols may be used singly or a combination of two or more trivalent or higher aliphatic alcohols may be used.

The polyester resin having the urethane bond and/or the urea bond is not particularly limited and may be appropriately selected according to a purpose. Examples of the polyester resin having the urethane bond and/or the urea bond include a reaction product of a polyester resin having a reactive group having an active hydrogen and a polyisocyanate. The reaction product is preferably used as a reaction precursor (prepolymer) to react with a curing agent as described below.

Examples of the polyester resin having a reactive group having an active hydrogen include a polyester resin having a hydroxyl group.

The polyisocyanate is not particularly limited, and can be appropriately selected according to a purpose. For example, suitable polyisocyanates may include diisocyanate, trivalent or higher valent isocyanate, and the like.

Suitable diisocyanates may include, for example, aliphatic diisocyanates, alicyclic diisocyanates, aromatic diisocyanates, aliphatic-aromatic diisocyanates, isocyanurates, diisocyanates that block the above-described diisocyanates by phenol derivative, oxime, caprolactam, or the like.

Suitable aliphatic diisocyanates may include, for example, tetramethylenediisocyanate, hexamethylenediisocyanate, 2,6-diisocyanatomethylcaproate, octamethylenediisocyanate, decamethinediisocyanate, dodecamethylenediisocyanate, tetradecamethylenediisocyanate, trimethylhexanediisocyanate, tetramethylhexanediisocyanate, and the like.

Suitable alicyclic diisocyanates include isophorone diisocyanate, cyclohexylmethane diisocyanate, and the like. Examples of aromatic diisocyanates include trilene diisocyanate, diisocyanatodiphenylmethane, 1,5-naphthylene diisocyanate, 4,4′-diisocyanatodiphenyl, 4,4′-diisocyanato-3,3′-dimethyldiphenyl, 4,4′-diisocyanato-3-methyldiphenylmethane, 4,4′-diisocyanate-diphenyl ether, and the like.

Examples of aromatic aliphatic diisocyanates include α,α,α′,α′-tetramethylxylylene diisocyanate and the like.

Examples of isocyanurates include tris (isocyanatoalkyl) isocyanurate, tris (isocyanatocycloalkyl) isocyanurate, and the like.

The above-described polyisocyanates may be used singly, or a combination of two or more polyisocyanates may be used.

The curing agent is not particularly limited as long as the curing agent can react with the prepolymer, and may be suitably selected according to a purpose. For example, reactive group having an active hydrogen-containing compounds and the like can be used.

The reactive group having an active hydrogen in the reactive group having an active hydrogen containing compounds is not particularly limited, and can be appropriately selected according to a purpose. For example, suitable reactive groups having an active hydrogen may include hydroxyl groups (alcoholic hydroxyl groups and phenolic hydroxyl groups), amino groups, carboxyl groups, mercapto groups, and the like. The above-described reactive group having an active hydrogen may be used singly, or a combination of two or more reactive group having an active hydrogen may be used.

Amines are preferred as the reactive group having an active hydrogen containing compounds in that amines are capable of forming urea bonds.

Suitable amines may include, for example, diamines, trivalent or higher amines, amino alcohols, amino mercaptans, amino acids, amines that block the above-described amino groups, and the like. The above-described amines may be used singly, or a combination of two or more amines may be used. Among them, a diamine, or a mixture of a diamine and a small amount of the trivalent or higher amine is preferable.

Suitable diamines may include, for example, aromatic diamines, alicyclic diamines, aliphatic diamines, and the like. The aromatic diamines include, for example, phenylenediamine, diethyltoluenediamine, 4,4′-diaminodiphenylmethane, and the like.

Suitable alicyclic diamines include, for example, 4,4′-diamino-3,3′-dimethyldicyclohexylmethane, diaminocyclohexane, isophoronediamine, and the like. The aliphatic diamines include, for example, ethylenediamine, tetramethylenediamine, hexamethylenediamine, and the like.

The trivalent or higher amines include, for example, diethylene triamine, triethylenetetramine, and the like.

The amino alcohols include, for example, ethanolamine, hydroxyethylaniline, and the like.

The amino mercaptans include, for example, amino ethylmercaptan, aminopropylmercaptan, and the like.

The amino acids include, for example, aminopropionic acid, aminocapronic acid, and the like.

The amines that block the amino groups include, for example, ketimine compounds obtained by blocking the amino groups with ketone, such as acetone, methylethylketone, or methylisobutylketone, an oxazoline compound, and the like.

The molecular structure of the amorphous crystalline polyester resin may be determined by the NMR using a liquid or solid sample, the X-ray diffraction, the GC/MS, the LC/MS, the IR spectroscopy, or the like. Simply, the molecular structure may be determined based on the infrared absorption spectrum in which an absorption based on an out-of-plane bending vibration (δCH) of olefin is not observed at 965±10 cm⁻¹ and at 990±10 cm⁻¹, as an example.

The compound ratio (A/C) of the amount (A) of the non-crystalline polyester resin of the toner (including the precursor of the non-crystalline polyester resin) and the amount (C) of the crystalline polyester resin is preferably within a range from 95/5 to 70/30, and more preferably within a range from 95/5 to 85/15.

If the compound ratio (A/C) is within a range from 95/5 to 70/30, it is possible to achieve both low temperature fixing property and heat resistant preservability. If the compound ratio of the crystalline polyester resin is 95/5 or more, the low temperature fixing property can be well maintained.

In addition, if the compound ratio of the crystalline polyester resin is 70/30 or less, it is possible to prevent the amount of the crystalline polyester resin present on the top surface of the toner from being too large, and it is possible to suppress the deterioration of image quality, the deterioration of fluidity of the developer, and the decrease of image density due to contamination of the photoconductor or other member. Further, since the surface property of the toner deteriorates, the carrier is contaminated, and sufficient charging cannot be maintained for a long period of time. Further, it is possible to effectively prevent the problem of interfering with the environmental stability.

The compound amount of the crystalline polyester resin and the amorphous polyester resin in the toner of the present embodiment can be calculated using any conventional method. For example, the mass ratios of the components can be calculated by separating components of the toner by GPC or the like and adopting the analytical method described below for each of the separated components.

For example, the components may be separated using the GPC as follows.

In the GPC of tetrahydrofuran (THF) as a moving phase, sampling is performed for an eluted liquid by a fraction collector or the like, and fractions of the liquid corresponding to the desired molecular weights are collected from among the fractions in the entire area of the elution curve.

The collected eluted liquid is condensed and dried by an evaporator or the like, and the collected solid is dissolved in deuterated solvent such as deuterochloroform or deuterotetrahydrofuran. Then, the sample is subjected to proton nuclear magnetic resonance (¹H-NMR) analysis, and from integration ratios of the respective elements, constituent monomer ratios of the resin in the eluted components are calculated.

Moreover, alternatively, the constituent monomer ratios may be calculated by the following method. The eluted liquid is condensed, and the condensed liquid is subjected to hydrolysis using sodium hydroxide or the like, qualitative analysis is performed for the decomposition products using high performance liquid chromatography (HPLC) or the like.

An example of the method of separating the components in the analysis of the toner will be described in detail.

One gram of the toner is dissolved in 100 mL of THF, the THF is agitated for thirty minutes under the condition of the temperature of 25° C. The solution is filtered by a membrane filter having a mesh size of 0.2 μm, and the THF soluble component in the toner is obtained. Then, the soluble component is dissolved in THE to prepare a sample for GPC. The sample is injected into the GPC used for the above-described measurement of the molecular weight of the resin.

Moreover, a fraction collector is arranged at an eluted liquid exhaust port, an eluted liquid is sampled for every predetermined number of counts, and an eluted liquid of each 5% in area rates from an elution start of the elution curve (a rise of the curve). Then, for each elution, a sample of 30 mg is dissolved in deuterochloroform of 1 mL, and tetramethylsilane (TMS) of 0.05 volume % as a reference substance is added, to prepare a control sample.

The solution of the control sample is filled in a glass tube having a diameter of 5 mm for the NMR. Using a nuclear magnetic resonance apparatus (JNM-AL400, by JEOL Ltd.), 128 integrations are performed under the condition of the temperature within the range from 23° C. to 25° C., and a spectrum is obtained.

The monomer compositions and configuration ratios of the crystalline polyester resin, the amorphous polyester resin, and the like included in the toner are obtained from peak integration ratios in the above-described spectrum.

In addition, solubility parameters (SP values) (a unit is cal^{1/2}/cm^{3/2}) of the crystalline polyester resin and the amorphous polyester resin may be controlled. Here, solubility parameters (SP values) are an indicator of affinity, and two components with SP values close to each other indicate high affinity (easy to mix), and two components with SP values far apart indicate low affinity (difficult to mix).

When a difference (ASP) between the SP values of the crystalline polyester resin and the amorphous polyester resin is too small, the crystalline polyester resin becomes plasticized and compatible with the amorphous polyester resin. Thus, a crystal grows, and the crystalline polyester resin cannot maintain the spherical shape of the toner particle. On the other hand, when the difference (ASP) is too great, the crystalline polyester resin makes no progress in the plasticizing, and the effect of the low temperature fixing property is not exhibited.

Thus, the difference (ΔSP) preferably is within a range from 1.40 cal^{1/2}/cm^{3/2} to 1.65 cal^{1/2}/cm^{3/2}.

Other characteristics of the toner according to the present embodiment and the measuring method thereof will be described below.

The particle size of the crystalline polyester resin in a crystalline polyester resin dispersion liquid can be measured using, for example, a nanotrack particle size distribution measuring apparatus (UPA-EX150, by Nikkiso Co., Ltd., using a dynamic light scattering method/a laser Doppler method).

Specifically, the measurement is performed for the crystalline polyester resin dispersion liquid with the concentration which is adjusted so as to be within a measurement range. A background measurement is performed only with a solvent for the crystalline polyester resin dispersion liquid, before analyzing the sample. By the above-described measurement method, the measured particle sizes of the crystalline polyester resin particles may range from several tens of nanometers to several micrometers.

In the present embodiment, the particle size of the crystalline polyester resin in the crystalline polyester resin dispersion liquid is preferably within a range from 10 nm to 500 nm, and more preferably within a range from 30 nm to 300 nm. The particle size of the crystalline polyester resin refers to a volume average particle diameter (volume mean diameter).

A melting point and a glass transition temperature Tg can be measured using, for example, a differential scanning calorimeter (DSC) system (Q-200, by TA Instruments, Inc.).

Specifically, the melting point and the glass transition temperature of the sample can be measured according to the following steps. The sample of about 5.0 mg is put in a sample container made of aluminum, the sample container is placed on a holder unit, and set in an electric furnace.

Then, the sample is heated from −80° C. to 150° C. under a nitrogen atmosphere at a rate of 10° C./min (first temperature increase). Then, the sample is cooled from 150° C. to −80° C. at a temperature falling rate of 10° C./min, and heated again to 150° C. at a rate of 10° C./min (second temperature increase). In each of the first and second temperature increases, a DSC curve is measured using a differential scanning calorimeter (DSC) system (Q-200, by TA Instruments, Inc.).

The DSC curve for the first temperature increase is selected, and the glass transition temperature in the first temperature increase for the sample is obtained from the DSC curves using an analysis program in the Q-200 system. Similarly, the DSC curve for the second temperature increase is selected, and the glass transition temperature in the second temperature increase for the sample is obtained from the DSC curve.

The DSC curve for the first temperature increase is selected, and a heat absorbing peak top temperature in the first temperature increase for the sample is obtained as the melting point from the DSC curve using the analysis program in the Q-200 system. Similarly, the DSC curve for the second temperature increase is selected, and a heat absorbing peak top temperature in the second temperature increase for the sample is obtained as the melting point from the DSC curve.

In the embodiment of the present application, the melting point and the glass transition temperature Tg of the component for the sample refer to the heat absorbing peak top temperature and the glass transition temperature Tg in the first temperature increase, unless otherwise noted.

Molecular weights of the crystalline polyester resin, the amorphous polyester resin, the vinyl polymer modified polyester resin, and the like are measured using the GPC, unless otherwise noted with the conditions as follows.

Device: HLC-8220GPC (by Tosoh Corporation);

Column: TSKgel (trademark registered) of SuperHZM-Mx3 (by Tosoh Corporation);

Temperature: 40° C.;

Solvent: tetrahydrofuran (THF);

Flow rate: 0.35 mL/min; and

Sample: sample with the concentration of 0.05 to 0.6 mass' is injected by 0.01 mL.

From the molecular weight distribution of the toner resin measured with the above-described conditions, the weight-average molecular weight Mw is calculated using a calibration curve prepared based on monodispersed polystyrene standard sample.

For the above-described calibration, ten points of the monodispersed polystyrene standard sample, for example, 5.8×100; 1.085×10,000; 5.95×10,000; 3.2×100,000; 2.56-1,000,000; 2.93×1,000; 2.85×10,000; 1.48×100,000; 8.417×100,000; and 7.5×1,000,000 are used.

The toner according to the embodiment of the present application may include a coloring agent, a mold release agent, resin fine particles, a charging control agent, inorganic fine particles, flowability improving agent, cleanability improving agent, a magnetic material, and the other components such as a metallic soap.

The coloring agent is not particularly limited, and can be appropriately selected according to a purpose from among conventional dyes and pigments.

Suitable coloring agents may include, for example, carbon black, nigrosine dye, iron black, naphthol yellow S, hansa yellow (10G, 5G, G), cadmium yellow, yellow iron oxide, loess, chrome yellow, titan yellow, polyazo yellow oil yellow, hansa yellow (GR, A, RN, R), pigment yellow L, benzidine yellow (G, GR), permanent yellow (NCG), vulcan fast yellow (5G, R), tartrazine lake, quinoline yellow lake, anthracite yellow BGL, isoindolinone yellow, colcothar, red lead, vermilion, cadmium red, cadmium mercury red, antimony vermilion, permanent red 4R, paranitraniline red, fire red, para chloro ortho nitro aniline red, lithol fast scarlet G, brilliant fast scarlet, brilliant carmine BS, permanent red (F2R, F4R, FRL, FRLL, F4RH), fast scarlet VD, vulcan fast rubine B, brilliant scarlet G, lithol rubine GX, permanent red F5R, brilliant carmine 6B, pigment scarlet 3B, bordeaux 5B, toluidine maroon, permanent bordeaux F2K, helio bordeaux BL, bordeaux 10B, bon maroon light, bon maroon medium, eosine lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkaline blue lake, peacock blue lake, victoria blue lake, metal-free phthalocyanine blue, phthalocyanine blue, fast sky blue, indanthrene blue (RS, BC), indigo, ultramarine blue, prussian blue, anthraquinone blue, fast violet B, methyl-violet lake, cobalt violet, manganese violet, dioxane violet, anthraquinone violet, chrome green, zinc green, chrome oxide, viridian, emerald green, pigment green B, naphthol green B, green gold, acid green lake, malachite green lake, phthalocyanine green, anthraquinone green, titanium oxide, zinc white, lithopone, and the like.

The above-described coloring agents may be used singly, or a combination of two or more coloring agents may be used.

The content of the coloring agent in the toner is not particularly limited, and can be appropriately selected according to a purpose. The content preferably is within a range from 1 mass % to 15 masss, and more preferably is within a range from 3 mass to 10 mass %. When the content of the coloring agent is 1 mass % or more, it is possible to suppress lowering of the coloring power of the toner. When the content of the coloring agent is 15 mass % or less, it is possible to efficiently suppress degradation of the coloring of the toner and electric characteristic of the toner due to insufficiency in dispersion of the pigments in the toner.

The coloring agent may be used as a master batch combined with a resin.

The resin is not particularly limited, and can be appropriately selected according to a purpose from among conventional resins.

Examples of the resins include polyesters, styrene or substituted styrene polymers, styrene-based copolymers, polymethyl methacrylates, polybutylmethacrylates, polyvinyl chlorides, polyvinyl acetates, polyethylenes, polypropylenes, epoxy resins, epoxy polyol resins, polyurethanes, polyamides, polyvinyl butyrals, polyacrylic acid resins, rosins, modified rosins, terpene resins, aliphatic hydrocarbon resins, alicyclic hydrocarbon resins, aromatic based petroleum resins, chlorinated paraffins, paraffin waxes, and the like.

The above-described resins may be used singly, or a combination of two or more resins may be used.

Suitable styrene or substituted styrene polymers may include, for example, polyester resins, polypara chlorostyrenes, polyvinyl toluenes, and the like.

Suitable styrene based copolymers may include, for example, styrene-para chrolostyrene copolymers, styrene-propylene copolymers, styrene-vinyl toluene copolymers, styrene-vinyl naphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-α-chloro methyl methacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, styrene-maleic ester copolymers, and the like.

The master batch can be manufactured by mixing or kneading the selected resin and the coloring agent while applying high shearing force. During the manufacturing, an organic solvent is preferably added to them to enhance the interaction between the coloring agent and the resin. Moreover, the so-called flushing method is also preferable in that a wet cake of the coloring agent can be used as it is, thereby rendering a drying step unnecessary.

In the flushing method, an aqueous paste including the coloring agent and water is mixed or kneaded with the resin and the organic solvent, the coloring agent is thereby transferred to the resin, and the water and the organic solvent are subsequently removed. In the mixing or kneading step, for example, a high shear and dispersion apparatus, such as a three-roll mill, is preferably used.

It is known that the coloring agents degrade the charging performance of the toner when the coloring agents are present on the surface of the toner. Thus, as the master batch is adopted to the resin, the charging performance of the toner in terms of an environmental stability, charge retaining capacity, and a charge amount can be improved.

The release agent is not particularly limited, and can be appropriately selected according to a purpose. A low melting point release agent having a melting point being within a range from 50° C. to 120° C. is preferable. The low melting point release agent is dispersed with the resin, and thereby the release agent exhibits a high releasing effect between the fixing roller and an interface of the toner. Thus, hot offset property is excellent even if a release agent such as lubricant is not applied (oilless) on a surface of the fixing roller.

The release agents preferably include, for example, waxes or the like.

The waxes include, for example, natural waxes including botanical waxes such as carnauba wax, cotton wax, japan wax, and rice wax; animal waxes such as beeswax, and lanolin; mineral-based waxes such as ozocerite, and selsyn; and petroleum waxes such as paraffin, microcrystalline, and petrolatum; and the like.

Moreover, in addition to the above-described natural waxes, the release agents may include synthetic hydrocarbon waxes such as fischer-tropsch waxes, and a polyethylene waxes; synthetic waxes such as esters, ketones, and ethers; and the like.

Furthermore, aliphatic acid amides such as 12-hydroxystearic acid amide, amide stearate, phthalimide anhydride, or chlorinated hydrocarbons; homopolymers or copolymers of polyacrylate such as poly-n-stearyl methacrylate, or poly-n-lauryl methacrylate, which is a crystalline high polymer resin with a low molecular weight (e.g. a copolymer of n-stearyl acrylate-ethyl methacrylate); a crystalline polymer having a long alkyl group in the side chain; and the like may be used.

The above-described polymers may be used singly, or a combination of two or more polymers may be used.

The melting point of the release agent is not particularly limited, and can be appropriately selected according to ta purpose. The melting point preferably is within a range from 50° C. to 120° C., and more preferably is within a range from 60° C. to 90° C. When the melting point is 50° C. or higher, it is possible to suppress bad influence brought from the wax to the heat resistant preservability. When the melting point is 120° C. or lower, it is possible to effectively suppress an occurrence of a cold offset at the time of fixing at low temperature.

A melt viscosity of the release agent, as a measured value at a temperature higher than the melting point of the release agent by 20° C., preferably is within a range from 5 cps to 1,000 cps, and more preferably is within a range from 10 cps to 100 cps. When the melt viscosity is 5 cps or more, it is possible to retain acceptable releasability. When the melt viscosity is 1,000 cps or less, effects of hot offset resistance and the low temperature fixing property can be exhibited sufficiently.

The content of the release agent in the toner is not particularly limited, and can be appropriately selected according to a purpose. The content preferably is within a range from 0 mass %, to 40 mass %, and more preferably is within a range from 3 mass % to 30 masse. When the content is 40 mass % or less, it is possible to suppress deterioration of fluidity of the toner.

The resin of the resin fine particles is not particularly limited, as long as an aqueous dispersion can be formed in a water-based medium, and can be appropriately selected according to a purpose from among the conventional resins.

The resin of the resin fine particles may be a thermoplastic resin or a thermosetting resin. The resins include, for example, vinyl resin, polyurethane resin, epoxy resin, polyester resin, polyamide resin, polyimide resin, silicon resin, phenol resin, melamine resin, urea resin, aniline resin, ionomer resin, polycarbonate resin, and the like. The above-described resins may be used singly, or combination of two or more resins may be used.

Among them, the resin of the resin fine particles is preferably formed of at least one resins selected from the vinyl resin, the polyurethane resin, the epoxy resin and the polyester resin, from the point that an aqueous dispersion of small resin fine particles having spherical shapes can be easily obtained.

Moreover, the vinyl resin is a polymer obtained by homopolymerizing or copolymerizing vinyl monomers. Suitable vinyl resins may include, for example, styrene-(meth)acrylic ester resins, styrene-butadiene copolymers, (meth) acrylic acid-ester acrylate polymers, styrene-acrylonitrile copolymers, styrene-maleic anhydrides, styrene-(meth)acrylic acids, and the like.

A charge control agent is not particularly limited, and can be appropriately selected according to a purpose, from conventional agents.

The charge control agents include, for example, nigrosine dye, triphenylmethane dye, chromium-including metal complex dye, chelate molybdate dye, rhodamine-based dye, alkoxyamine, quaternary ammonium salt (including fluorine-modified quaternary ammonium salt), alkylamide, simple substance phosphorus or a compound thereof, a simple substance tungsten or a compound thereof, a fluorine-based activator, a metallic salt of salicylic acid, a metallic salt of a salicylic acid derivative, and the like.

The above-described agents may be used singly, or a combination of two or more agents may be used.

Commercially available charge control agents may be used. Suitable examples may include, for example, resins or compounds having an electron donating functional group, azo dyes, metal complexes of organic acid, and the like.

Specific examples of commercially available products include BONTRON 03, which is nigrosine dye, BONTRON P-51, which is quaternary ammonium salt, BONTRON S-34, which is metal including azo dye, E-82, which is oxynaphtoic acid-based metal complex, E-84, which is salicylic acid metal complex, and E-89, which is phenolic condensate (by Orient Chemical Industries Co., Ltd.); TN-105, which is salicylic acid metal complex, and TP-302 and TP-415, which are quaternary ammonium salt molybdenum complexes (by Hodogaya Chemical Co., Ltd.); copy charge PSY VP2038, which is quaternary ammonium salt, copy blue PR, which is triphenylmethane derivative, copy charge NEG VP2036, which is quaternary ammonium salt, and copy charge NX VP434 (by Hoechst AG); LRA-901, and LR-147, which is boron complex, (by Japan Carlit Co., Ltd.); copper phthalocyanine, perylene, quinacridone, azo-based dyes, and polymer compounds having a functional group, such as a sulfonate group, a carboxyl group, a quaternary ammonium salt; and the like.

The charge control agent can be included as necessary in the resin phase in the toner particle using difference in affinity for the resins in the toner particle. By causing the charge control agent to be selectively included in the resin phase in the toner particle that is present in an inner layer, occurrent of toner spent of the charge control agent to the other units such as a photoconductor, or a carrier, can be suppressed.

In a method of manufacturing a toner according to the embodiment of the present application, the charge control agent may be arranged relatively freely. In addition, the charge control agent can be arranged freely according to the image formation process.

Inorganic fine particles are used as external additives to provide fluidity, developability, and electrostatic chargeability to the toner particle. The inorganic fine particles are not particularly limited, and can be appropriately selected according to a purpose from among conventional materials.

Suitable inorganic fine particles may include, for example, silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, read lead paint, antimony trioxide, magnesium oxide, zirconium oxide, barium sulfate, barium carbonate, calcium carbonate, silicon carbide, silicon nitride, and the like.

The above-described materials may be used singly, or a combination of two or more materials may be used.

As the inorganic fine particles for assisting the fluidity, the developability and the electrostatic chargeability of the toner particles, inorganic fine particles with small particle diameters are preferably used in addition to the inorganic fine particles with large particle diameters, i.e. having a primary average particle diameter that is within a range from 80 nm to 500 nm. In particular, hydrophobic silicas and hydrophobic titanium oxides are preferably used as the inorganic fine particles.

The primary average particle diameter of the inorganic fine particles preferably is within a range from 5 nm to 50 nm, and more preferably is within a range from 10 nm to 30 nm. Moreover, the specific surface area of the inorganic fine particles measured using the Brunauer-Emmett-Teller (BET) method preferably is within a range from 20 m²/g to 500 m²/g. The use ratio of the inorganic fine particles preferable is within a range from 0.01 mass % to 5 masse of the toner, and more preferably is within a range from 0.01 mass % to 2.0 mass % of the toner.

The fluidity improver is an agent that performs a surface treatment to improve hydrophobicity so as to suppress the degradation of fluidity and chargeability even under an environment of high humidity.

The fluidity improvers include, for example, silane coupling agent, silylating agent, silane coupling agent having fluorinated alkyl group, an organic titanate coupling agent, an aluminum based coupling agent, silicone oil, modified silicone oil, and the like. Silica and titanium oxide are preferably subjected to the surface treatment using the above-described fluidity improver, and used as hydrophobic silica and hydrophobic titanium oxide, respectively.

A cleanability improver is an agent that is added to the toner to remove any developer that remains on the photoconductor and on a primary transfer medium after transferring a toner image.

The cleanability improvers include, for example, zinc stearate, calcium stearate, metallic salt of fatty acid such as stearic acid, polymer fine particles manufactured by soap-free emulsion polymerization, such as polymethyl methacrylate fine particles, and polystyrene fine particles, and the like. The polymer fine particles preferably have relatively narrow particle size distribution. The volume average particle diameter, preferably is within a range from 0.01 μm to 1 μm.

The magnetic material is not particularly limited, and can be appropriately selected according to a purpose from among the conventional materials. For the magnetic material, for example, iron power, magnetite, ferrite, or the like may be used. Among them, white material is preferable from the point of color tone.

According to the toner of the present embodiment, the method of manufacturing the shell is to add resin particles for the shell to the slurry of core particles, and the resin particles are uniformly adhered to the surface of the core by using the difference in electric charge in the slurry. For example, metal salts can be added to the resin particles for the shell, which tend to agglomerate, or the pH can be adjusted so that the resin particles for the shell, which tend to agglomerate. Thereby, the shell particles are adhered around the core particles.

For the toner particles to which the fine particles adhere, the shell formation step is performed while leaving the organic solvent used in fusing the toner, or a new organic solvent is added to the slurry, so that the shell layer can be melted and smoothed at a temperature at which the crystalline polyester resin is dissolved but not compatibilized.

The method of identifying the crystalline polyester resin in the shell is not particularly limited. However, in a cross-sectional image of a Transmission Electron Microscope (TEM) photograph, for example, the shell layer can be identified by the difference in the dyeing method and the presence of the wax domain which is a component of the core and the layer in which the fine coloring particles are not present.

The topmost layer of the toner particles is stained and identifiable only by exposing the toner powder in a sealed container to the vapors of the previously mentioned staining agents prior to embedding the toner particles in an embedding resin. The presence of domains with the characteristic lamellar structure of the crystalline resin particles within 50 nm from this topmost layer to the interior of the toner particles can be determined by observing 20 toner particles.

In order to uniformly dispose the crystalline polyester particles within the toner, the crystalline polyester resin has amphiphilicity to both crystalline polyester resin and an amorphous polyester resin present in a matrix form in the toner. Because the toner according to the embodiment of the present application can stabilize crystalline polyester resin particles in the toner, the crystalline polyester resin particles can be dispersed uniformly inside the toner.

In particular, in the present embodiment, it is preferable to include the aqueous dispersion of crystalline polyester resin particles and the phase inversion emulsion fine particles of the oil phase to form the core particles. At this time, it is considered that the crystalline polyester resin particles remain inside the core particles in the water.

The modified resin can be manufactured by a method including a step of a polycondensation reaction by a raw material monomer of a polyester resin part (a polycondensation step), and a step of an addition polymerization reaction by a raw material monomer of a vinyl-based resin part (an addition polymerization step).

The addition polymerization step may be performed after the polycondensation step, or the polycondensation step may be performed after the addition polymerization step. Alternatively, the addition polymerization step and the polycondensation step may simultaneously performed. Moreover, the polycondensation step and the addition polymerization step are preferably performed in the same reaction container.

Moreover, polycondensation resin that was previously polymerized may be used instead of performing the polycondensation reaction. In the case of performing the polycondensation reaction in parallel with the addition polymerization reaction, the reaction may be performed by dropping a mixture including the raw material monomer of the vinyl resin part into a mixture including the raw material monomer of the polyester resin part.

The (meth) acrylic compound is preferably (meth) acrylic acid alkyl ester.

Suitable (meth) acrylic acid alkyl esters may include methyl (meth) acrylate, ethyl (meth) acrylate, (iso) propyl (meth) acrylate, (iso) butyl (meth) acrylate, or the like. The above-described esters may be used singly, or a combination of two or more esters may be used.

In the specification of the present application, the term “(iso)” indicates that the case in which the group is present and the case in which the group is absent are included. When the group is absent, the ester is “normal”.

The “(meth) acrylic acid” means acrylic acid, methacrylic acid, or both the acrylic acid and the methacrylic acid.

The raw material monomer of the vinyl resin part preferably further includes styrene compounds from a point of controlling a glass transition point Tg of the toner to secure the preservability.

Suitable styrene compounds may include styrenes, α-methyl styrenes, styrene derivatives such as vinyltoluene, and the like.

The alcohol component of the crystalline polyester resin preferably includes aliphatic diol of 6 to 12 carbon atoms.

Suitable aliphatic diols of 6 to 12 carbon atoms may include, 1,6-hexane diol, 1,7-heptane diol, 1,8-octane diol, 1,9-nonane diol, 1,10-decane diol, 1,11-undecane diol, 1,12-dodecane diol, and the like.

The carboxylic acid component of the crystalline polyester resin preferably includes aliphatic dicarboxylic acid-based compound of 4 to 14 carbon atoms from a viewpoint of the low temperature fixing property.

Suitable aliphatic dicarboxylic acid-based compounds of 4 to 14 carbon atoms may include a succinic acid (carbon number is 4), suberic acid (carbon number is 8), azelaic acid (carbon number is 9), sebacic acid (carbon number is 10), dodecanedioic acid (carbon number is 12), tetradecanedioic acid (carbon number is 14), succinic acid having an alkyl group or an alkenyl group on side chain, anhydrates of the above-described acids, alkyl esters of 1 to 3 carbon atoms of the above-described acids, and the like.

In the embodiment of the present application, the carboxylic acid-based compounds include not only free acids, but also anhydrates that are decomposed during the reactions to generate acids, and alkyl esters of 1 to 3 carbon atoms. The carbon number of the alkyl group of the alkyl ester part is not included in the carbon number of the aliphatic dicarboxylic acid-based compound.

The dimensions of the crystalline polyester resin in the toner are measured on the basis of the observed image of the ultrathin section of the toner observed by transmission electron microscopy (TEM). The domain of the crystalline polyester resin can be determined by the presence or absence of lamellar structure by a 100,000-fold magnification.

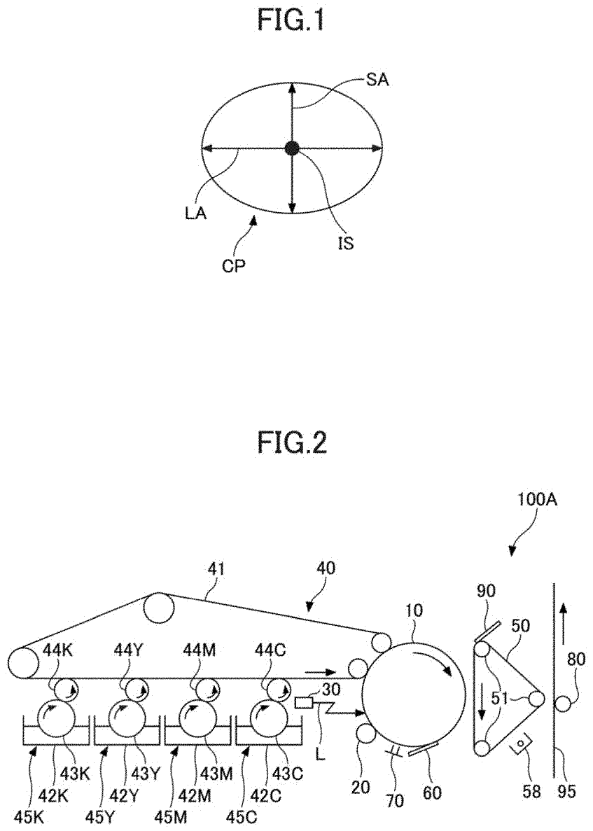

FIG. 1 illustrates an image of a crystalline polyester resin in a toner. In FIG. 1, the reference numeral CP denotes a particle (crystalline polyester particle) of a crystalline polyester resin. The crystalline polyester particle (CP) has a long axis LA and a short axis SA through the intersection (distance measuring center) IS. For the crystalline polyester resin CP, the length of the long axis LA represents the maximum length, and the length of the short axis SA represents the minimum length.

If the particles are pulverized and dispersed, the particle size can be adjusted by the energy, time, and the material of the media given to pulverize and disperse the particles. If the phase inversion emulsification method is performed, the particle size can be adjusted by neutralizing agents, degree of neutralization, pH at the time of inversion, oil-water ratio, type and amount of surfactant used, and type of organic solvent.

Observations and measurements by TEM are performed as follows. The prepared toner is embedded in epoxy resin or the like and cured. Then, an ultrathin slice sample of the toner with a thickness of around 100 nm is prepared using ultramicrotome (ULTRACUT UCT, using a diamond knife, by Leica GmbH).

The sample is exposed in gas using ruthenium tetroxide, osmium tetroxide, or other staining agents, or the like, to stain the sample so as to identify a part of the crystalline polyester resin and the other parts. The exposure time is appropriately adjusted according to contrast at the time of the observation. Then, the sample is observed using the TEM (JEM-2100, manufactured by JEOL) with an acceleration voltage of 100 kV.

According to a composition of the crystalline polyester resin and the amorphous polyester resin, the part of the crystalline polyester resin may be identified without staining. In such a case, the crystalline polyester resin is evaluated without staining. Moreover, the crystalline polyester resin may be evaluated by performing preprocessing of providing contrast by the other methods such as selective etching, and observing by the TEM.

The observed image of a cross section is subjected to binarization processing using commercially available image processing software (e.g. Image-Pro Plus), and the maximum length and the projected area of the toner are obtained. The above-described observation is performed for 20 toners, and the maximum lengths of the respective toners are obtained. An average of the maximum lengths is defined to be the maximum length of the crystalline polyester resin in the embodiment of the present application.

At the same time, the average value of the minimum length illustrated in FIG. 1 is obtained, and the average value of the maximum length and the average value of the minimum length are used as the aspect ratio.

In the toner according to the present embodiment, the aspect ratio of the crystalline polyester in the toner is 1 to 3, and preferably 1 to 2. As used herein, the aspect ratio represents the ratio of the long diameter LA to the short axis SA in crystalline polyester resin particles CP.

The crystalline polyester resin having the aspect ratio of 1 to 3 prevents exposure to the toner surface from entering the shell layer. This is thought to be due to the fact that when the toner is formed, sharp portions of the crystalline polyester resin do not penetrate the shell portion even when the crystalline polyester resin is near the surface of the lower shell layer. Further, if the aspect ratio of the crystalline polyester resin is 1 to 2, penetration into the shell layer is further inhibited.

In the toner according to the present embodiment, the average length of the longitudinal diameter of the crystalline polyester is within a range from 10 nm to 500 nm, and preferably within a range from 30 nm to 300 nm. As used herein, the average length of the longitudinal diameter of the crystalline polyester represents the arithmetic average length (maximum length) of the longest portion of the primary particle in the observed image of the crystalline polyester resin.

Since the particle size of the crystalline polyester resin inside the toner is within a range from 30 nm to 500 nm, the crystalline polyester resin can efficiently plasticize the surrounding amorphous resin (melting the resin at low temperature). If the particle size of the crystalline polyester resin inside the toner is smaller than the above-described range, the particles are more likely to penetrate into the shell layer.

In addition, when the average length of the longitudinal diameter of the crystalline polyester is within a range from 50 nm to 300 nm, high efficiency for promoting plasticization can be obtained according to the relationship of the contact area between the crystalline polyester resin and the amorphous polyester resin. In addition, the function of the crystalline polyester resin contained therein can be fully exerted, thereby improving low temperature fixing property.

In the toner of the present embodiment, when the aspect ratio of the crystalline polyester in the toner is within a range from 1 to 3, and the average length of the longitudinal diameter of the crystalline polyester is within a range from 10 nm to 500 nm, it is difficult for the resin component of the crystalline polyester to penetrate into the shell even if the resin component of the crystalline polyester is precipitated in the toner. Therefore, it is possible to prevent the resin component of the crystalline polyester precipitated in the toner from protruding onto the toner surface.

Accordingly, the toner according to the present embodiment has excellent low temperature fixing property and heat resistant preservability, and stable image quality (transferability) is obtained.

In the toner of the present embodiment, when the aspect ratio of the crystalline polyester in the toner is within a range from 1 to 2, the penetration of the resin component of the crystalline polyester into the shell layer is further suppressed. Therefore, it is possible to further prevent the resin component of the crystalline polyester precipitated in the toner from protruding onto the toner surface. This improves the low temperature fixing property and heat resistant preservability of the toner, and further stabilizes the image quality of the toner.

In the toner according to the present embodiment, when the average length of the longitudinal diameter of the crystalline polyester is within a range from 30 nm to 300 nm, high efficiency for promoting plasticization can be obtained according to the relationship of the contact area between the crystalline polyester resin and the amorphous polyester resin. In addition, the function of the crystalline polyester resin contained therein can be fully exerted, thereby improving low temperature fixing property.

In the toner of the present embodiment, the above-described aspect ratio and the average length of the longitudinal diameter are obtained, so that the lamellar structure of the crystalline polyester does not exist in the region within 50 nm from the surface layer of the shell. Therefore, even if the resin component of the crystalline polyester precipitated in the toner penetrates the shell, it is possible to prevent the resin component of the crystalline polyester from protruding onto the toner surface. This further improves the low temperature fixing property and heat resistant preservability of the toner, and further stabilizes the image quality of the toner.

In the toner of the present embodiment, as described above, the acid value of the resin constituting the shell is larger than the acid value of the resin constituting the core excluding the crystalline polyester. By increasing the acid value of the resin constituting the shell above the acid value of the resin constituting the core excluding the crystalline polyester, heat resistant preservability and transferability can be improved while maintaining low temperature fixing property.

<Method of Manufacturing the Toner>

A method of manufacturing the toner according to the embodiment of the present application is a method of manufacturing the toner described above, the method includes a step of preparing an oil phase in which at least a resin and a mold release agent are dissolved or dispersed in an organic solvent (oil phase preparation step); a step of causing a phase inversion from W/O emulsion to O/W emulsion by adding an aqueous medium into the oil phase (phase inversion emulsification step); and a step of adding a dispersion liquid of the crystalline polyester into the O/W emulsion (dispersion liquid addition step).

[Emulsification Agglomeration Method]

(Oil Phase Preparation Step)

In the method of manufacturing toner of the present embodiment, an oil phase in which a resin and a mold releasing agent are dissolved or dispersed in an organic solvent is first prepared. The colorant or prepolymer may also be dissolved or dispersed if necessary. In order to prepare the oil phase, the resin or the mold releasing agent may be gradually added to the organic solvent while stirring, and then dissolved or dispersed.

For dispersion, known dispersing machines such as, for example, a bead mill or a disk mill can be used.

The organic solvent is preferably volatile with a boiling point of less than 100° C. to facilitate subsequent removal of the organic solvent.

Examples of such organic solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, methanol, ethanol, isopropyl alcohol, and the like.

The above-described organic solvents may be used singly, or a combination of two or more organic solvents may be used.

When the resin to be dissolved or dispersed in the organic solvent is a resin having a polyester backbone, it is preferable to use ester-based solvents such as methyl acetate, ethyl acetate, butyl acetate, and the like or ketone-based solvents such as methyl ethyl ketone, methyl isobutyl ketone, and the like. Of these, methyl acetate, ethyl acetate, and methyl ethyl ketone, which are highly solvent removable, are more preferably used.

The step of adding pigments to the resulting oil phase may further include in the present embodiment.

(Phase Inversion Emulsification Step)

The oil phase obtained in the oil phase preparation step is then micronized. In the present embodiment, after the above-described oil phase is neutralized with neutralizing agent, an aqueous phase is added to it, and the fine particles dispersion liquid is obtained by the phase inversion emulsification in which W/O dispersion (W/O emulsion) is converted to O/W dispersion (O/W emulsion).

The neutralizing agent can be either a basic inorganic compound or a basic organic compound. Examples of the basic inorganic compounds include sodium hydroxide, potassium hydroxide, lithium hydroxide, ammonia, sodium carbonate, sodium hydrogen carbonate, potassium carbonate, potassium hydrogen carbonate, ammonia, and the like. Examples of the basic organic compounds include N,N-dimethylethanolamine, N,N-diethylethanolamine, triethanolamine, tripropanolamine, tributanolamine, triethylamine, n-propylamine, n-butylamine, isopropylamine, monomethanolamine, morpholine, methoxypropylamine, pyridine, vinylpyridine, isophoronediamine, and the like.

When the oil phase is neutralized, ordinary agitators or dispersing devices are used to uniformly mix and disperse the mixture. The dispersing devices are not limited, and include ultrasonic dispersers, bead mills, ball mills, roll mills, homo-mixers, ultramixers, disper-mixers, through-type high-pressure dispersing devices, collision-type high-pressure dispersing devices, porous-type high-pressure dispersing devices, ultra high-pressure homogenizers, ultrasonic homogenizers, and the like. Ordinary agitators and dispersing devices may be used in combination.

The aqueous phase is ion-exchanged water or ion-exchanged water containing organic solvents. Examples of the organic solvents include ester solvents such as methyl acetate, ethyl acetate, and butyl acetate, or ketone solvents such as methyl ethyl ketone, methyl isobutyl ketone, and the like. The concentration of the organic solvent should be less than or equal to the saturation concentration of the ion-exchanged water from the viewpoint of granulation.

When the mixture is emulsified, ordinary agitators or dispersing devices are used to uniformly mix and disperse the mixture. The dispersing devices are not limited, and include ultrasonic dispersers, bead mills, ball mills, roll mills, homo-mixers, ultramixers, disper-mixers, through-type high-pressure dispersing devices, collision-type high-pressure dispersing devices, porous-type high-pressure dispersing devices, ultra high-pressure homogenizers, ultrasonic homogenizers, and the like. Ordinary agitators and dispersing devices may be used in combination.

The methods of removing the organic solvent from the resulting fine particle dispersion liquid are the following four methods. (1) A method of gradually increasing the temperature of the entire reaction system to evaporate the organic solvent in droplets may be used. (2) Alternatively, a method of spraying the dispersion into a dry atmosphere to remove the organic solvent included in the droplets, and the like may be used. (3) Alternatively, the fine particle dispersion liquid may be stirred and decompressed to remove the organic solvent by evaporation. (4) Alternatively, the organic solvent can be evaporated and removed by blowing gas while stirring the fine particle dispersion liquid.

The above-described steps (2), (3), and (4) may be used in combination with the above-described step (1).

As the drying atmosphere in which the fine particle dispersion liquid is sprayed, various air currents heated to a temperature above the boiling point of the highest boiling solvent used are generally used, including air, nitrogen, carbon dioxide gas, combustion gas, and other heated gases.

Short-term treatment of spray dryers, belt dryers, rotary kilns, or the like provides sufficient target quality.

Examples of the blowing gases include heated air, nitrogen, carbon dioxide gas, and combustion gas.

The fine particle dispersion liquid can be obtained by the above-described method.

(Agglomeration Step)

Then, the obtained fine particle dispersion liquid is allowed to agglomerate to a desired particle size while stirring. Conventional methods can be used to cause agglomeration, such as adding an agglomerating agent or adjusting pH. When an agglomerating agent is added, the agglomerating agent may be added as is, but the agglomerating agent is preferably converted into an aqueous solution so that a localized increase in concentration is avoided. In addition, the agglomerated salt is preferably gradually added while observing the particle size.

The temperature of the dispersion liquid during agglomeration is preferably near the Tg of the resin used. If the liquid temperature is too low, agglomeration will not appreciably proceed, resulting in poor efficiency. If the liquid temperature is too high, the coarse particle size distribution will deteriorate, such as the generation of coarse particles.

When the particle size becomes a desired particle size, the agglomeration is stopped. Methods for stopping agglomeration include adding salts or chelating agents with low ionic valence, adjusting the pH, lowering the temperature of the dispersion liquid, and diluting the concentration by adding a large amount of aqueous medium.

The above method can be used to obtain the dispersion liquid (fine particle dispersion liquid) of the agglomerated particles. The resulting particulate dispersion is an example of an O/W emulsion in the present embodiment.

(Dispersion Liquid Addition Step)

In the above-described agglomeration step, a crystalline resin is added to the fine particle dispersion liquid (O/W emulsion) for low temperature fixing property, and wax is added as a mold releasing agent if necessary. In this case, a dispersion liquid in which wax is dispersed in an aqueous medium or a dispersion liquid in a crystalline resin may be prepared, mixed with the aforementioned fine particle dispersion liquid, and then agglomerated to obtain agglomerated particles in which wax and crystalline resin are uniformly dispersed.

As an agglomerating agent, a known agent can be used. For example, a metal salt of a monovalent metal such as sodium, potassium, or the like; a metal salt of a divalent metal such as calcium, magnesium, or the like; or a metal salt of a trivalent metal such as iron, aluminum, or the like; may be used.

(Fusing Step)

The resulting agglomerated particles are then fused by heat treatment to reduce irregularities. The fusion may be accomplished by heating the dispersion of the agglomerated particles while stirring. Preferably, the temperature of the liquid is around the temperature exceeding the Tg of the resin being used.

(Cleaning and Drying Step)

Since the toner particle dispersion liquid obtained by the above-described method contains a sub-material such as agglomerated salt in addition to the toner particles, cleaning is performed in order to remove only the toner particles from the dispersion liquid.

Methods of cleaning the toner particles include a centrifugal separation method, a vacuum filtration method, and a filter press method. The methods of cleaning the toner particles are not particularly limited in the present embodiment.

A cake body of the toner particles can be obtained by either method. If the toner particles cannot be sufficiently cleaned in a single operation, the cake obtained can be dispersed in an aqueous solvent again to make a slurry, and the step of removing the toner particles by either of the above methods can be repeated. If the cleaning is performed by a reduced-pressure filtration or filter press method, an aqueous solvent may be used to penetrate the cake and wash away the secondary materials that the resin particles have attached.

As the water-based solvent used for this cleaning, water or a mixture of water and an alcohol such as methanol and ethanol are used. Water is preferably used in view of the environmental load due to cost and waste water treatment.

Since the cleaned toner particles contain a large amount of water-based media, the toner particles only can be obtained by drying and removing the water-based media.

As the drying method, a dryer such as a spray dryer, a vacuum freeze dryer, a vacuum dryer, a static dryer, a mobile dryer, a fluidized dryer, a rotary dryer, a stirred dryer, or the like, can be used.

The dried toner particles are preferably dried until the final moisture content is less than 1′.

If the colored resin particles after drying are flocculated and impractical for use, the flocculated particles may be pulverized using a device such as a jet mill, a Henschel mixer, a super mixer, a coffee mill, an Oster blender, or a hood processor to break up the flocculated particles.

(Annealing Step)

When crystalline resin is added, the crystalline resin and the amorphous resin are phase separated by annealing (or annealing) after drying, thereby improving fixing property. Specifically, the product should be stored at a temperature around Tg for at least 10 hours.

(External Addition Step)

The toner particles obtained according to the present embodiment may be added to or mixed with the fine inorganic particles, the polymer-based fine particles, the cleaning aid, or the like in order to provide fluidity, charging, cleaning property, or the like.

Suitable methods may include, for example, applying an impact to the mixture using blades rotating at a high speed, throwing the mixture into a high-speed airflow to accelerate the mixture, and causing the particles to collide with each other or causing the particles to collide with an impact plate, and the like.

A device to be used for applying the mechanical impact to the mixture can be appropriately selected according to a purpose. For the device, angmill (by Hosokawa micron corporation), a device obtained by modifying I-type mill (by Nippon Pneumatic Mfg. Co., Ltd.) to reduce a pulverizing air pressure, a hybridization system (by Nara machinery Co., Ltd.), Kryptron (trademark registered) (by Kawasaki Heavy Industries, Ltd.), automatic mortar, or the like, may be used.

A cleanability improver agent to remove any developer that remains on the photoconductor and on a primary transfer medium after transferring a toner image is, for example, zinc stearate, calcium stearate, metallic salt of fatty acid such as stearic acid, polymer fine particles manufactured by soap-free emulsion polymerization, such as polymethyl methacrylate fine particles, and polystyrene fine particles, and the like.

The polymer fine particles preferably have relatively narrow particle size distribution. The volume average particle diameter, preferably is within a range from 0.01 μm to 1 μm.

[Dissolution Suspension Method]

As the method of manufacturing the toner, if the above-described requirements defined by the present embodiment can be satisfied, the method used in the related art can be used accordingly.

For example, methods of dispersion or emulsification of crystalline polyester resin include a method using a mechanical grinder, an injection granulation method, and a phase inversion emulsification method in which water is added to a solution in which crystalline polyester resin is dissolved in an organic solvent to convert the oil phase to the water phase.

Using the phase inversion emulsification method, particle size control is easy, and fine particles of crystalline polyester resin with narrow particle size distribution can be obtained. Since it is difficult to obtain fine particles with narrow particle size distribution using mechanical pulverizing equipment, the phase inversion emulsification method is more preferable.

In addition, as a method of introducing the fine particles of crystalline polyester resin produced by the phase inversion emulsification method into the toner, the dissolution suspension method is suitable. The pulverization and emulsification agglomeration methods are difficult to maintain the shape of particles in spherical form due to the use of heat in the steps, and the heat can partially plasticize the crystalline polyester resin with the amorphous resin.

As described above, it is also important to adjust the SP values of the crystalline polyester resin and the amorphous polyester resin.

If the difference (ASP) between the SP value of the crystalline polyester resin and the SP value of the amorphous polyester resin is too small, the crystalline polyester resin becomes plasticized and compatible with the amorphous resin so that the crystal grows and cannot be maintained in its spherical shape. On the other hand, if the ASP is too large, plasticization of the crystalline polyester resin does not progress, and low temperature fixing property cannot be achieved.

In the toner according to the present embodiment, the toner contains a crystalline polyester resin, and preferably contains an amorphous polyester resin that is a prepolymer having a urethane and/or urea bond and an amorphous polyester resin not having a urethane and/or urea bond. The toner is preferably manufactured by a method including a step of granulating toner particles by dispersing an oil phase containing a curing agent, a releasing agent, a coloring agent, and the like in an aqueous medium.

In the step of manufacturing the toner, the aqueous dispersion liquid of the crystalline polyester is poured into the oil phase containing styrene/(meth)acrylic acid ester modified polyester, amorphous polyester, a curing agent, a mold releasing agent, and a coloring agent, and then dispersed in the aqueous medium to granulate the toner. This allows the position of the crystalline polyester resin to be adjusted.

At this time, a modified resin of a styrene acrylic resin and a polyester resin is added to the oil phase including the crystalline polyester resin and the amorphous polyester resin, as a dispersion assistant. Accordingly, the crystalline polyester resin is taken into the inside of the toner, and the position of the crystalline polyester resin dispersed inside the toner is adjusted.

In order to realize crystalline resin in a near spherical form in the toner, it is necessary to adjust the crystalline resin in the form of fine particles, and after blending it into the toner, it is necessary to conduct a step that does not allow melting of the crystalline resin or compatibility of the crystalline resin with the amorphous resin.

In this method, the crystalline polyester resin can be mechanically dispersed to obtain the crystalline polyester dispersion liquid (solvent dispersion liquid). In addition, it is preferable to prepare an emulsion dispersion liquid (water dispersion liquid) of the crystalline polyester resin by phase inversion emulsification and perform toner conversion. By emulsifying the emulsion by phase inversion emulsification, a water dispersion liquid of a spherical crystalline polyester resin with a good particle size distribution can be produced.

In order to composite the aqueous dispersion of the crystalline polyester resin with the aqueous dispersion of other toner constituents, it is preferable that the crystalline polyester resin aggregate up to the toner size.

When the difference (ca^{1/2}/cm^{3/2}) of the SP (solubility parameters) between the crystalline polyester resin and the amorphous polyester resin, which is the main resin, is somewhat high, the toner can be obtained without the crystals of the crystalline polyester growing at the time of preparation of the toner while maintaining the emulsion particle size.

The steps in the dissolution suspension method, such as preparing an aqueous medium, preparing an oil phase containing the toner material, emulsifying or dispersing the toner material, and removing the organic solvent, are described below.

Preparation of the aqueous medium can be accomplished, for example, by dispersing the resin particles in the aqueous medium. The amount of the crystalline polyester resin particles added to the aqueous medium is not particularly limited, and can be appropriately determined according to a purpose. The amount of the crystalline polyester resin particles added to the aqueous medium is within a range from 0.5 to 10 parts by mass relative to 100 parts by mass of the aqueous medium.

The aqueous medium is not particularly limited, and can be appropriately selected according to a purpose. Suitable aqueous media may include, for example, water, solvents miscible with water, mixtures thereof, and the like. The above-described media may be used singly, or a combination of two or more media may be used. Among them, water is preferably used.

The solvent miscible with water can be appropriately selected according to a purpose. Suitable solvents may include, for example, alcohols, dimethylformamides, tetrahydrofurans, cellosolves, lower ketones, and the like. Suitable alcohols may include, for example, methanols, isopropanols, ethylene glycols, and the like. Suitable lower ketones may include, for example, acetones, methylethylketones, and the like.

The oil phase containing the toner material can be prepared by dissolving or dispersing the toner material in an organic solvent including an amorphous polyester resin which is a prepolymer having a urethane bond and/or a urea bond, an amorphous polyester resin having no urethane bond and/or urea bond, and a crystalline polyester resin, and further including a curing agent, a releasing agent, a coloring agent, and the like.

The organic solvent is not particularly limited, and can be appropriately selected according to a purpose. The organic solvent having a boiling point lower than 150° C. is preferably used from a point that the solvent is easy to be removed.

The organic solvents having the boiling point lower than 150° C. include, for example, toluene, xylene, benzene, carbon tetrachloride, methylene chloride, 1,2-dichloroethane, 1,1,2-trichloroethane, trichloroethylene, chloroform, monochloro benzene, dichloro ethylidene, methyl acetate, ethyl acetate, methylethylketone, methyl isobutyl ketone, and the like. The above-described solvents may be used singly, or a combination of two or more solvents may be used.

Of these, ethyl acetate, toluene, xylene, benzene, methylene chloride, 1,2-dichloroethane, chloroform, carbon tetrachloride, and the like are preferable, of which ethyl acetate is more preferable.

Emulsification or dispersion of the toner material can be accomplished by dispersing the oil phase containing the toner material in an aqueous medium. The curing agent and the prepolymer can then be extended and/or crosslinked in emulsifying or dispersing the toner material.

In the present embodiment, the step of adding the pigment to the oil phase may further include.

The reaction conditions (reaction time, reaction temperature) for forming the prepolymer are not particularly limited and may be appropriately selected depending on the combination of the curing agent and the prepolymer. The reaction time is preferably from 10 minutes to 40 hours, and more preferably from 2 hours to 24 hours. The reaction temperature is preferably within a range from 0 to 150° C. and more preferably within a range from 40 to 98° C.

The method of stably forming a dispersion liquid containing a prepolymer in the aqueous medium is not particularly limited and may be selected according to a purpose. For example, a method in which the oil phase prepared by dissolving or dispersing the toner material in a solvent is added to the aqueous medium phase and dispersed by shear force is included.

A disperser for performing the dispersion can be appropriately selected according to a purpose. Suitable dispersers may include, for example, low-speed shearing type dispersers, high-speed shearing type dispersers, friction type dispersers, high-pressure jet type dispersers, ultrasonic wave dispersers, and the like. Among them, the high-speed shearing type disperser is preferable from a point that the particle diameters of dispersions (oil droplets) can be controlled so as to be within a range from 2 μm to 20 μm.

When the high-speed shearing type disperser is used, conditions such as revolution speed, dispersion time, or a dispersion temperature can be appropriately selected according to a purpose.

The revolution speed of the disperser preferably is within a range from 1,000 rpm to 30,000 rpm, and more preferably is within a range from 5,000 rpm to 20,000 rpm. The dispersion time preferably is within a range from 0.1 minutes to 5 minutes in batch mode. The dispersion temperature preferably is within a range from 0 to 150° C. under pressure, and more preferably is within a range from 40 to 98° C. In general, as the dispersion temperature becomes higher, the dispersion occurs more easily.

The amount of aqueous medium used in emulsifying or dispersing the toner material can be appropriately selected according to a purpose. The amount used preferably is within a range from 50 parts by mass to 2000 parts by mass, and more preferably is within a range from 100 parts by mass to 1000 parts by mass, with respect to 100 parts by mass of the toner material.

When the amount used of the aqueous medium is 50 part by mass or more, it is possible to suppress the degradation of the dispersion state of the toner material, and the toner base particles having the predetermined particle diameter can be obtained. When the amount used of the aqueous medium is 2000 part by mass or less, production cost can be reduced.

In emulsifying or dispersing the oil phase containing the toner material, it is preferable to use a dispersant in order to stabilize the dispersion, such as oil droplets, to have a desired shape and to sharpen the particle size distribution.

The dispersant is not particularly limited. The dispersant can be appropriately selected according to a purpose. Suitable dispersants may include, for example, surfactant, poorly water-soluble inorganic compound dispersant, polymer-based protective colloid, and the like. The above-described dispersants may be used singly, or a combination of two or more dispersants may be used. Of the above dispersants, surfactants are preferable.

The surfactant is not particularly limited. The surfactant can be appropriately selected according to a purpose. Suitable surfactants may include, for example, anionic surfactants, cationic surfactants, nonionic surfactants, amphoteric surfactants, and the like. Suitable anionic surfactants may include, for example, alkylbenzene sulfonates, α-olefin sulfonates, phosphoric esters, and the like. Of the above dispersants, compounds that include a fluoroalkyl group are preferably used.

The method of removing the organic solvent from the dispersion liquid such as emulsion slurry can be appropriately selected according to a purpose. The methods include, for example, gradually increasing the temperature of the entire reaction system to evaporate the organic solvent in oil droplets, spraying the dispersion into a dry atmosphere to remove the organic solvent included in the oil droplets, and the like.

Once the organic solvent is removed, the toner base particles are formed. By performing a washing step, a drying step and the like, it is possible to, for example, further classify the collected toner base particles. The classification process may be performed by removing a portion of the fine particles using a cyclone separator, a decanter, a centrifugal separator, or the like. Alternatively, the classification process may be performed after the drying step.

The resulting toner base particles may be mixed with particles of an external additive, a charging control agent, or the like. At the time of mixing, by applying mechanical impact to a mixture, it is possible to suppress desorption of particles of the external additive or the like from surfaces of the toner base particles.

The method of applying the mechanical impact the mixture can be appropriately selected according to a purpose. Suitable methods may include, for example, applying an impact to the mixture using blades rotating at a high speed, throwing the mixture into a high-speed airflow to accelerate the mixture, and causing the particles to collide with each other or causing the particles to collide with an impact plate, and the like.

A device to be used for applying the mechanical impact to the mixture can be appropriately selected according to a purpose. For the device, Angmill (by Hosokawa Micron Corporation), a device obtained by modifying I-type mill (by Nippon Pneumatic Mfg. Co., Ltd.) to reduce a pulverizing air pressure, a hybridization system (by Nara machinery Co., Ltd.), Kryptron (trademark registered) (by Kawasaki Heavy Industries, Ltd.), automatic mortar, or the like, may be used.

In the method of manufacturing the toner according to the present embodiment, the toner particles are heated at the lower temperature of either of a melting temperature of the crystalline polyester resin or a temperature of a glass transition point of the resulting toner. Specifically, spherical particles can be disposed in the toner by suppressing compatibility with the amorphous resin when being produced by the emulsification agglomeration method, and the toner can be produced by treating the particles below the Tg of the amorphous resin or below the melting point of the crystalline resin to fuse the particles.

The toner particles are heated at the lower temperature of either of a melting temperature of the crystalline polyester resin or a temperature of a glass transition point of the resulting toner. The heating temperature is not particularly limited, and can be selected according to a purpose. For example, the temperature range below the Tg of the amorphous resin or the melting point of the crystalline resin is below 70° C., preferably below 65° C., more preferably below 60° C., and even more preferably below 55° C.

In order to fuse the fine particles constituting the toner without applying heat, the crystalline polyester resin does not dissolve at the processing temperature, but the amorphous resin coexists with organic solvents capable of dissolving and swelling. In this case, the oil phase containing the crystalline polyester resin, the amorphous resin, or the pigment may be allowed to agglomerate while leaving the organic solvent used for phase inversion.

The aspect ratio can be adjusted depending on the amount of organic solvent remaining, the temperature during toner manufacturing, the agitation conditions of the toner slurry, and the like.

The aspect ratio can also be adjusted by cooling the crystalline polyester resin once it has been compatibilized and then recrystallizing it by adding annealing treatment as described above.

The method of manufacturing the toner according to the present embodiment preferably includes the step of adding a prepolymer to the W/O emulsion. Specifically, it is more preferable to use a dissolution suspension method in which the toner base particles are formed while the polyester resin is formed by an extension reaction and/or crosslinking reaction between the prepolymer and the curing agent.

The method of manufacturing the toner according to the present embodiment includes the above-described oil phase preparation step, the phase inversion emulsification step, and the dispersion liquid addition step, the above-described toner is obtained. In addition, as described above, the obtained toner has excellent low temperature fixing property and heat resistant preservability, and has stable image quality (transferability).

The method of manufacturing the toner according to the present embodiment includes the step of adding a pigment to the oil phase as described above, so that the pigment can be dispersed in the oil phase of the W/O dispersion before conversion to the O/W dispersion. Therefore, in the method of manufacturing the toner according to the present embodiment, the pigment can be stably dispersed in the oil phase in the O/W dispersion after the phase inversion.

Further, in the method of manufacturing the toner according to the present embodiment, as described above, the toner particles are heated at the lower temperature of either of a melting temperature of the crystalline polyester resin or a temperature of a glass transition point of the resulting toner. Accordingly, according to the method of manufacturing the toner according to the present embodiment, heat resistant preservability and transferability can be improved while maintaining low temperature fixing property.

Furthermore, in the method of manufacturing the toner according to the present embodiment, as described above, the prepolymer can be dispersed in the aqueous phase of the O/W dispersion converted from the water-in-water dispersion by the step of adding the prepolymer to the W/O emulsion. Therefore, according to the method of manufacturing the toner according to the present embodiment, the prepolymer can be stably dispersed in the O/W dispersion after the phase inversion.

The developer according to the embodiment of the present application includes the toner according to the embodiment of the present application. The developer may include a carrier or the like, which is selected as necessary. Thus, the appropriate fluidity of the toner is secured even when the temperature is high and the humidity is high. Moreover, it is possible to transfer images with little contamination and perform the development. Accordingly, the developer having excellent environmental stability (reliability) can be provided.

The developer may be single component developer and may be two components developer. In the case of using for a high-speed printer, or the like, corresponding to the recent enhancement in the information processing speed, from a point of enhancing the lifetime of the printer, two components developer is preferably used.

In the case where the above-described developer is used as single component developer, even when an incoming and an outgoing of the toner is performed, the toner exhibits little variation in the particle size, little filming on the developing roller, and little adhesion to a member such as a blade that forms a thin layer of the toner. Thus, even when the toner is stirred for a long time, excellent and stable developing property and image are obtained.

In the case where the above-described developer is a two-component developer, even when an incoming and an outgoing of the toner is performed for a long time, variation in the particle size of the toner is small; and even when the toner is stirred for a long time in the developing device, excellent and stable developing property and image are obtained.

The carrier is not particularly limited, and can be selected appropriately according to a purpose. The carrier is preferably provided with a core and a resin layer that coats the core.

The material use as the core is not particularly limited, and can be appropriately selected according to a purpose. Suitable materials of the core may include, for example, manganese-strontium based materials with a magnetization that is within a range from 50 emu/g to 90 emu/g, manganese-magnesium based materials with magnetization that is within a range from 50 emu/g to 90 emu/g.

Moreover, to secure an image density, iron power with a magnetization of 100 emu/g or greater, and a high magnetization material such as magnetite with magnetization that is within a range from 75 emu/g to 120 emu/g are preferably used. Moreover, a low magnetization material such as copper-zinc based material with magnetization that is within a range from 30 emu/g to 80 emu/g is preferably used, because it is possible to relax the impact to the photoconductor of the developer, in a napping state, and it is advantageous for improving the image quality. The above-described materials may be used singly, or a combination of two or more materials may be used.

The volume average particle diameter of the core is not particularly limited, and can be appropriately determined according to a purpose. The volume average particle diameter preferably is within a range from 10 μm to 150 μm, and more preferably is within a range from 40 μm to 100 μm. When the volume average particle diameter is 10 μm or more, it is possible to effectively suppress problems such as increases in the amount of fine powders in the carrier, decreases in the magnetization per individual particle, and scattering of the carriers.

When the volume average particle diameter is 150 μm, it is possible to effectively suppress problems such as decreases in the specific surface area, occurrence of scattering of the toner, and poor reproduction of solid image portion in a full-color image including a lot of solid image portions.

The toner of the present embodiment can be mixed with a carrier and used as a developer.

The content of the carrier in the two-component developer can be appropriately determined according to a purpose. The content preferably is within a range from 90 parts by mass to 98 parts by mass, and more preferably is within a range from 93 parts by mass to 97 parts by mass relative to 100 parts by mass of the two-components developer.

The developer according to the embodiment of the present application can preferably be used to form images using the conventional electrophotography, such as a magnetic monocomponent development method, a nonmagnetic monocomponent development method, or a two components development method.

<Toner Storage Unit>

A toner storage unit according to the embodiment of the present application can store the toner of the embodiment of the present application. The toner storage unit according to the embodiment of the present application refers to a unit provided with function of storing a toner and storing the toner. Modes of the toner storage unit include, for example, a toner storage container, a developing unit, and a process cartridge.

The toner storage container refers to a container that stores a toner.

The developing unit refers to a unit that stores a toner and has a developing unit.

The process cartridge refers to a unit which is obtained by integrating at least an electrostatic latent image carrier (also referred to as an image carrier) and a developing unit, stores a toner, and is attachable/detachable to/from an image forming apparatus. The process cartridge may be provided with at least one selected from a charging unit, an exposure unit, a clearing unit, and the like. A specific example of a process cartridge that is part of the toner storage unit in this form is illustrated in FIG. 6 and explained below.

By using the toner described above in the toner storage unit of the present application, the effects obtained with the toner described above can be obtained. Because the toner storage unit according to the embodiment of the present application is mounted in the image forming apparatus that forms an image using the toner according to the embodiment of the present application, it is possible to form images by taking advantage of the toner's features, which have excellent low temperature fixing property and heat preservation properties, and furthermore, excellent image quality.

<Image Forming Apparatus and Method of Forming Image>

The image forming apparatus according to the embodiment of the present application includes an electrostatic latent image carrier; an electrostatic latent image formation unit that forms an electrostatic latent image on the electrostatic latent image carrier; a developing unit that develops the electrostatic latent image formed on the electrostatic latent image carrier using the toner to form a toner image; a transfer unit that transfers the toner image to a recording medium; and a fixing unit that fixes a transfer image transferred on a surface of the recording medium.

In the image forming apparatus according to the present embodiment, the toner used is the above-described toner. The image forming apparatus can further be provided with another component, as necessary.

A method of forming an image according to the present embodiment includes an electrostatic latent image forming step of forming an electrostatic latent image on the electrostatic latent image carrier, a developing step of developing the electrostatic latent image formed on the electrostatic latent image carrier using toner to form a toner image, a transfer step of transferring the toner image formed on the electrostatic latent image carrier to the recording medium, and a fixing step of fixing the toner image transferred to the recording medium.

In the image forming method according to the present embodiment, the toner used is the above-described toner. The image forming method according to this embodiment further includes other steps as necessary.

The image forming method according to the present embodiment can be preferably performed by the image forming apparatus according to the present embodiment.

The electrostatic latent image forming step of the image forming method can be preferably performed by the electrostatic latent image forming unit of the image forming apparatus, and the developing step of the image forming method can be preferably performed by the developing unit of the image forming apparatus. The transfer step of the image forming method can be preferably performed by the transfer unit of the image forming apparatus, and the fixing step of the image forming method can be preferably performed by the fixing unit of the image forming apparatus.

The other steps of the image forming method can be preferably performed by other units of the image forming apparatus.

[Electrostatic Latent Image Carrier]

A material, a structure, a size, and the like of the electrostatic latent image carrier according to the embodiment of the present application are not particularly limited, and can be appropriately selected from the conventional ones. The materials of the electrostatic latent image carrier include, for example, an inorganic photoconductor such as amorphous silicon, or selenium, an organic photoconductor such as polysilane, or phthalo polymethine, and the like. Among them, amorphous silicon is preferably used from the viewpoint of longevity.

[Electrostatic Latent Image Forming Unit and Electrostatic Latent Image Forming Step]

The electrostatic latent image formation unit is not particularly limited as long as it is a unit for forming an electrostatic latent image on the electrostatic latent image carrier, and can be appropriately selected according to a purpose. The electrostatic latent image formation unit according to the embodiment of the present application is provided with a charging member that charges a surface of the electrostatic latent image carrier, and an exposure member that exposes image-wise the surface of the electrostatic latent image carrier.

The electrostatic latent image formation step is not particularly limited as long as it is a unit for forming an electrostatic latent image on the electrostatic latent image carrier, and can be appropriately selected according to a purpose. The electrostatic latent image formation unit according to the embodiment of the present application is provided with a charging member (charging unit) that charges a surface of the electrostatic latent image carrier uniformly, and an exposure member (exposure unit) that exposes imagewise the surface of the electrostatic latent image carrier.

[Charging Unit and Charging Step]

The charging unit is not particularly limited, and can be appropriately selected according to the purpose. The charging units include, for example, a contact charger provided with an electrically conductive or semiconductive roller, a blush, a film, a rubber blade, and the like; a non-contact charger utilizing corona discharge, such as a corotron, or a scorotron, and the like.

The charging step can be performed, for example, by applying a voltage to the surface of the electrostatic latent image carrier using charging units.

[Exposure Unit and Exposure Step]

The exposure unit is not particularly limited as long as it can expose with an image to be formed onto the surface of the electrostatic latent image carrier electrified by the charging unit, and can be appropriately selected according to a purpose. The exposure units include, for example, various types of exposure units of a copying optical system, a rod lens array system, a laser optical system, a liquid crystal shutter optical system, and the like.

[Developing Unit and Developing Step]

The developing unit is not particularly limited as long as it can develop the above-described electrostatic latent image formed on the electrostatic latent image carrier and form a visible image, and can include the toner. The developing unit can be appropriately selected according to a purpose.

The developing step is not particularly limited as long as the step can develop the above-described electrostatic latent image formed on the electrostatic latent image carrier with use of the toner and form a visible image, and can be appropriately selected according to a purpose. For example, the developing unit can be used.

The developing unit may be a dry developer or a wet developer. The developing unit may be a developing unit for single color, or may be a multicolor developing unit. For example, the developing unit is preferably provided with a stirring device that performs friction stirring for a toner to electrify the toner, and has a rotatable developer carrier carrying the developer containing the toner on its surface.

[Transfer Unit and Transfer Step]

The transfer unit is not particularly limited as long as it can transfer a visible image to a recording media, and can be appropriately selected according to a purpose. The transfer unit is preferably provided with a primary transfer unit that transfers a visible image to an intermediate transfer body to form a composite transfer image, and a secondary transfer unit that transfers the composite transfer image to a recording medium.

As a transfer step, the transfer step is not particularly limited as long as the transfer step can transfer a visible image to a recording medium, and can be appropriately selected according to a purpose. However, it is preferable to transfer the visible image to the recording medium using an intermediate transfer body, and then transfer the visible image to the recording medium.

[Fixing Unit and Fixing Step]

The fixing unit is not particularly limited as long as the fixing unit can fix the transferred image on the recording medium, and can be appropriately selected according to a purpose. The fixing unit is preferably a conventional heating and pressurizing device. The heating and pressurizing devices include, for example, a combination of a heating roller and a pressurizing roller, a combination of a heating roller, a pressuring roller and an endless belt, and the like.

As the fixing step, the fixing step is not particularly limited as long as the fixing step can fix the transferred image on the recording medium, and can be appropriately selected according to a purpose. For example, the fixing step may be performed by transferring the toner of each color to the recording medium, or the fixing step may be performed at the same time by laminating the toner of each color.

[Other Measures and Other Steps]

The image forming apparatus may be provided with the other units, such as a cleaning unit, a discharging unit, a recycling unit, a control unit, and the like.

The step of the present embodiment may also include, for example, a cleaning step, a discharging step, a recycling step, a controlling step, and the like.

Next, an example of a method of forming an image by the image forming apparatus according to the present embodiment will be described with reference to FIG. 2.

The image forming apparatus 100A illustrated in FIG. 2 includes a photoconductor drum 10 which is an electrostatic latent image carrier (hereinafter, may refer to as a photoconductor 10 or an electrostatic latent image carrier 10); a charging roller 20 which is an charging unit; an exposure device 30 which is an exposure unit; a developing device 40 which is a developing unit; an intermediate transfer body 50; a cleaning device 60 which is a cleaning unit; and a discharging lamp 70 which is a discharging unit.

The intermediate transfer body 50 is an endless belt stretched by three rollers 51 that are arranged inside the image forming apparatus, and is designed to be moved in the arrow direction by three rollers 51 disposed inside the belt and stretching the intermediate transfer body. A portion of the three rollers 51 also functions as a transfer bias roller capable of applying a predetermined transfer bias (primary transfer bias) to the intermediate transfer body 50. The cleaning apparatus 90 having a cleaning blade is disposed near the intermediate transfer body 50.

Moreover, near the intermediate transfer body 50, the transfer roller 80 is arranged so as to oppose to the intermediate transfer body 50, and the transfer roller 80 can apply transfer bias (a secondary transfer bias) to the intermediate transfer body 50, so as to transfer (secondarily transfer) a developed image (a toner image) to a transfer paper 95 which is a recoding medium.

Around the intermediate transfer body 50, a corona charging unit 58 for giving electric charges to the toner image on the intermediate transfer body 50 is arranged between a contact part between the photoconductor 10 and the intermediate transfer body 50 and a contact part between the intermediate transfer body 50 and the transfer paper 95, with respect to a rotational direction of the intermediate transfer body 50.

The developing device 40 includes a developing belt 41 which is a developer carrier; a black developing unit 45K, a yellow developing unit 45Y, a magenta developing unit 45M, and a cyan developing unit 45C provided around the developing belt 41.

The black developing unit 45K includes a developer storage part 42K, a developer supplying roller 43K, and a developing roller 44K.

The yellow developing unit 45Y includes a developer storage part 42Y, a developer supplying roller 43Y, and a developing roller 44Y.

The magenta development unit 45M includes a developer storage part 42M, a developer supplying roller 43M, and a developing roller 44M.

The cyan developing unit 45C includes a developer storage part 42C, a developer supplying roller 43C, and a developing roller 44C.

The developing belt 41 is an endless belt and is rotatably stretched to a plurality of belt rollers, and a portion of the developing belt 41 is in contact with the electrostatic latent image carrier 10.

In the image forming apparatus 100A illustrated in FIG. 2, a surface of the photoconductor drum 10 is uniformly electrified using the charging roller 20, and the photoconductor drum 10 is exposed with exposure light L using the exposure device 30 to form an electrostatic latent image. Then, the electrostatic latent image formed on the photoconductor drum 10 is developed with a toner supplied from the developing device 40 to form a toner image.

The toner image formed on the photoconductor drum is transferred (primary transfer) onto the intermediate transfer body 50 according to transfer bias applied by the roller 51. Then, the toner image is further transferred (secondary transfer) onto a transfer paper 95. As a result, a transfer image is formed on the transfer paper 95. The remaining toner on the photoconductor 10 is removed by the cleaning device 60, and the static charge on the photoconductor 10 is once removed by the discharging lamp 70.

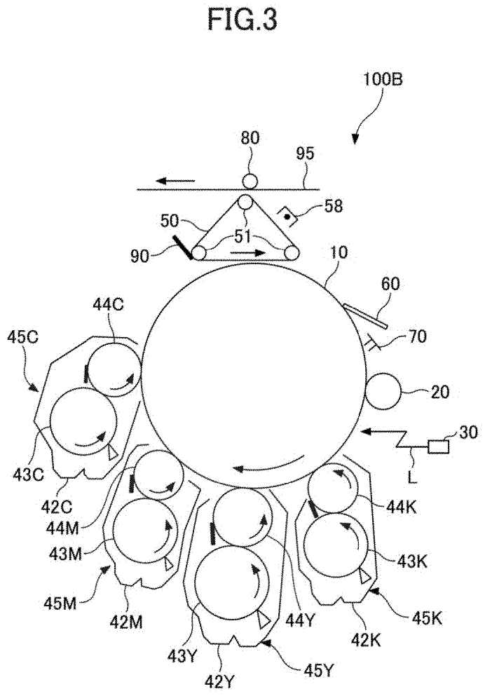

FIG. 3 illustrates another example of the image forming apparatus according to the present embodiment. In FIG. 3, parts in common with FIG. 2 may be omitted with the same symbols.

The image forming apparatus 100B is disposed around the photoconductor drum 10 without providing the above-described developing belt 41. The image forming apparatus 100B has the same configuration as that of the image forming apparatus 100A illustrated in FIG. 2, except that the black developing unit 45K, the yellow developing unit 45Y, the magenta developing unit 45M, and the cyan developing unit 45C are disposed around the photoconductor drum 10.

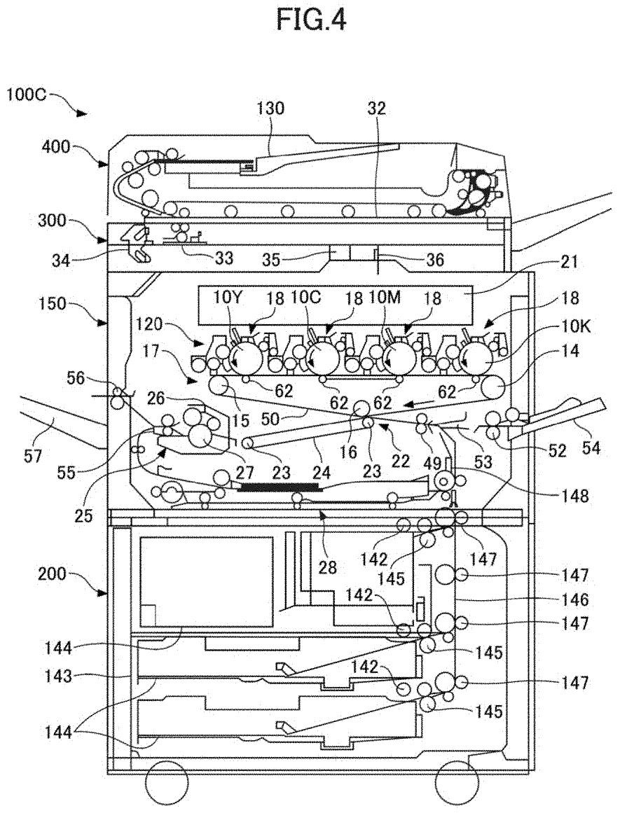

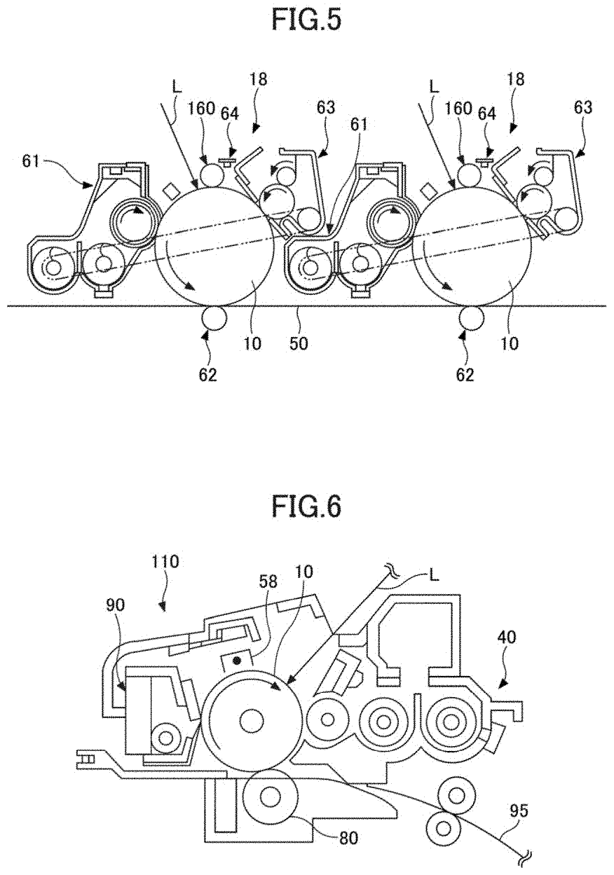

FIG. 4 illustrates another example of the image forming apparatus according to the present embodiment. FIG. 5 illustrates a partial enlarged view of FIG. 4. The image forming apparatus 100C illustrated in FIG. 4 includes a copying apparatus main body 150, a sheet feed table 200, a scanner 300, and an automatic document feeder (ADF) 400.

The copying device body 150 is provided with an endless belt-like intermediate transfer body 50 at the center thereof. The intermediate transfer body 50 is stretched over the support rollers 14, 15, and 16 and rotates clockwise in FIG. 4. An intermediate transfer unit 17 for removing the residual toner on the intermediate transfer unit 50 is disposed near the support roller 15.

In the intermediate transfer body 50 stretched by the support roller 14 and the support roller 15, a tandem-type developing device 120 in which four image forming units 18 of yellow, cyan, magenta, and black are arranged in parallel with each other along the conveying direction thereof is arranged. An exposure device 21 that is an exposure member is disposed in the vicinity of the tandem-type developing device 120.

In the intermediate transfer body 50, a secondary transfer device 22 is disposed on the opposite side of the tandem-type developing device 120. In the secondary transfer device 22, a secondary transfer belt 24, which is an endless belt, is suspended on a pair of rollers 23, so that the transfer paper conveyed on the secondary transfer belt 24 and the intermediate transfer member 50 are in contact with each other.

A fixing device 25, which is the fixing unit, is disposed near the transfer device 22. The fixing device 25 includes a fixing belt 26 and a pressing roller 27 that is pressed against the fixing belt 26.

In the tandem-type developing device 120, a paper reversing device 28 is disposed near the secondary transfer device 22 and the fixing device 25 for inverting the transfer paper in order to form an image on both sides of the transfer paper.

Next, a formation of a full color image (color copy) using the tandem-type developing device 120 will be described. First, an original document is set on a document feeder 130 of an automatic document feeder (ADF) 400, or the automatic document feeder 400 is opened to set the original document on a platen glass 32 of the scanner 300, and the automatic document feeder 400 is closed.

In the case the document is set in the automatic document feeder 400, when the start switch is pressed, the document is fed and moved to the platen glass 32. On the other hand, when the document is set on the platen glass 32, the scanner 300 is immediately driven. Then, the first traveling body 33 and the second traveling body 34 travel.

At this time, the light source from the first traveling body 33 emits light, and the reflected light from the surface of the original document reflects by a mirror in the second traveling body 34. Then, the light is received at a read sensor 36 through an imaging lens 35. Thus, the color document (the color image) is read, and image information of the respective colors of black, yellow, magenta, and cyan is obtained.

The image information of the black, yellow, magenta, and cyan is transmitted to each image forming unit 18 (the image forming unit for the black, the image forming unit for the yellow, the image forming unit for the magenta, and the image forming unit for the cyan) of the tandem-type developing device 120. Each image of black, yellow, magenta, and cyan is then formed in each image forming unit.

Each image forming unit 18 (black image forming unit, yellow image forming unit, magenta image forming unit, and cyan image forming unit) in the tandem-type developing device 120 includes an electrostatic latent image carrier 10 (black electrostatic latent image carrier 10K, yellow electrostatic latent image carrier 10Y, magenta electrostatic latent image carrier 10M, and cyan electrostatic latent image carrier 10C), respectively, as illustrated in FIGS. 4 and 5.

A charging device 160, which is a charging unit that uniformly charges the electrostatic latent image carrier 10, and an exposure device that exposes the electrostatic latent image carrier in an image-like manner corresponding to each color image based on each color image information to form an electrostatic latent image corresponding to each color image on the electrostatic latent image carrier are provided (see FIG. 5).

The image forming apparatus includes a developing device 61 that is a developing unit that develops an electrostatic latent image using each color toner (black toner, yellow toner, magenta toner, and cyan toner) to form a toner image by each color toner (see FIG. 5).

Further, a transfer charger 62 for transferring the toner image to the intermediate transfer body 50, a cleaning device 63, and a static elimination device 64 are provided (see FIGS. 4 and 5).

Each image forming unit 18 can form images of each monochromatic color (black images, yellow images, magenta images, and cyan images) based on the image information of each color.

The black image, yellow image, magenta image, and cyan image thus formed are respectively transferred onto the intermediate transfer body 50 which is rotated by the support rollers 14, 15, and 16.

Specifically, the black image, the yellow image, the magenta image, and the cyan image formed on the black electrostatic latent image carrier 10K, the yellow electrostatic latent image carrier 10Y, the cyan electrostatic latent image carrier 10C, and the magenta electrostatic latent image carrier 10M, respectively are sequentially transferred (primary transfer). Then, the black image, the yellow image, the magenta image, and the cyan image are superimposed on the intermediate transfer body 50 to form a composite color image (color transfer image).

Meanwhile, in the paper-feed table 200, one of the paper feed rollers 142 is selectively rotated, and the recording paper is ejected from one of paper-feed cassettes 144 provided in multiple stages in a paper bank 143. Each paper of the extended recording papers is separated by a separating roller 145 and fed to a paper-feed passage 146, conveyed by a conveying roller 147, guided to a sheet-feed passage 148 inside the main body of the copying machine 150, and hit against a resist roller 49 to stop the paper.

Alternatively, the recording paper on the manual feed tray 54 is fed out by rotating the paper feed rollers 142, separated one by one by a separating roller 52, placed in a manual feed passage 53, and hit and stopped against the resist roller 49. The resist roller 49 is generally used in a state of ground, but may be used while a bias is applied to remove paper powder from the recording paper.

The resist roller 49 is rotated by timing to the composite color image (the color transfer image) formed on the intermediate transfer body 50, and feeds the recording paper between the intermediate transfer body 50 and the transfer device 22, and transfers (secondary transfer) the composite toner image (the color transfer image) by the secondary transfer device 22 onto the recording paper. In this way, a color image is transferred to and formed on the sheet (recording sheet).

The toner remaining on the intermediate transfer body 50 after the composite toner image is transferred is removed by the cleaning device 17.

The recording paper on which the color image is transferred and formed is conveyed by the secondary transfer device 22 and transmitted to the fixing device 25. In the fixing device 25, the composite color image (color transfer image) is fixed to the recording paper by heat and pressure.

Thereafter, the recording paper is switched by a switching claw 55 and ejected by an ejection roller 56 and stacked on an ejection tray 57. Alternatively, the switching claw 55 is switched over and reversed by a reversing device 28 to be again guided to a transfer position, and an image is also formed on the back of the paper. Thereafter, the imaged formed paper is then ejected by an ejecting roller 56 and stacked on the ejection tray 57.

FIG. 6 illustrates an example of a process cartridge as an example of a toner storage unit according to the present embodiment. In FIG. 6, parts in common with FIG. 2 may be omitted with the same symbols.

The process cartridge 110 includes a photoconductor drum 10, a developing device 40, a corona charger 52, a transfer roller 80, and a cleaning device 90. An exposing light L is irradiated onto the photoconductor drum 10. A toner image is transferred onto a transfer paper 95.

The image forming apparatus according to the present embodiment includes the electrostatic latent image carrier, the electrostatic latent image forming units, the developing unit, the transfer unit, and the fixing unit, as described above. Since the toner is the above-described toner, an effect obtained with the toner is obtained. Specifically, since an image is formed by using the image forming apparatus according to the embodiment, it is possible to form an image using stable image quality (transferability) toner having excellent low temperature fixing property and heat resistant preservability.

In the image forming method according to the present embodiment, the above-described toner is used, and an effect obtained by the above-described toner is obtained. Specifically, by using the image forming method according to the present embodiment, an image is formed. Therefore, it is possible to form an image using the stable image quality (transferability) toner having excellent low temperature fixing property and heat resistant preservability.

### EXAMPLE

Although the present invention will be described in further detail with reference to the following examples, the present invention is not limited to these examples. “%” is, unless otherwise noted, mass standards. In addition, various tests and evaluations shall be conducted in accordance with the following methods.

### Manufacturing Example A-1: Synthesis of Amorphous Polyester Resin A-1

Two moles of ethylene oxide adduct (BisA-EO) of bisphenol A, three moles of propylene oxide adduct (BisA-PO), trimethylol propane (TMP), terephthalic acid, and adipic acid were charged into a four-necked flask having a nitrogen introduction tube, a dehydration tube, a stirrer, and a thermocouple.

The molar ratio of the two moles adduct of bisphenol A ethylene oxide, three moles adduct of bisphenol A propylene oxide, and trimethylol propane were set to be 38.6/57.9/3.5 (2 moles adduct of bisphenol A ethylene oxide/3 moles adduct of bisphenol A propylene oxide/trimethylol propane). The molar ratio of terephthalic acid and adipic acid was set to be 80/20 (terephthalic acid/adipic acid).

The OH/COOH ratio, the molar ratio of the hydroxyl group to the carboxyl group, was set to 1.2. Titanium tetraisopropoxide (500 ppm relative to the resin component) was reacted at 230° C. at atmospheric pressure for 8 hours. After a further 4 hours reaction at reduced pressure from 10 mmHg to 15 mmHg, the reaction container was charged with trimellitic anhydride to be 1 mol % of the total resin component and allowed to react at 180° C. and atmospheric pressure for 3 hours. Then, an amorphous polyester resin A-1 was obtained.

Tg of the amorphous polyester resin A-1 was 57.6° C., Mw was 10,000, and acid value was 20.

### Manufacturing Example A-2: Synthesis of Amorphous Polyester Resin A-2

The composition of the alcohol monomer and the acid monomer in Manufacturing Example A-2 is the same as the Manufacturing Example A-1, except that the OH/COOH, which is the molar ratio of the hydroxyl group and the carboxyl group, was set to 1.3. The reaction was performed in the same manner as in Manufacturing Example A-1 to obtain an amorphous polyester resin A-2. Tg of the amorphous polyester resin A-2 was 58.5° C., Mw was 11,000, and acid value was 25.

### Manufacturing Example A-3: Synthesis of Amorphous Polyester Resin A-3

The composition of the alcohol monomer and the acid monomer in Manufacturing Example A-3 is the same as the Manufacturing Example A-1, except that the OH/COOH, which is the molar ratio of the hydroxyl group and the carboxyl group, was set to 2.0. The reaction was performed in the same manner as in Manufacturing Example A-1 to obtain an amorphous polyester resin A-3. Tg of the amorphous polyester resin A-3 was 60.5° C., Mw was 10,000, and acid value was 40.

### Manufacturing Example B: Synthesis of Prepolymer B

97 mol % of 3-methyl-1,5-pentanediol and 3 moles of trimethylolpropane (TMP), as alcohol components with 50 mol % of adipic acid and 50 mol % of terephthalic acid, as acid components were charged into a reaction container equipped with a cooling tube, a stirrer, and a nitrogen introduction tube. At that time, OH/COOH was set to 1.1.

In addition, titanium tetraisopropoxide (300 ppm vs. resin component) was added together in the reaction container. Thereafter, the temperature was raised to 200° C. for about 4 hours, then the temperature was raised to 230° C. for about 2 hours, and the effluent was allowed to react until the effluent was no longer running. Subsequently, the mixture was reacted under reduced pressure from 10 mmHg to 15 mmHg for 5 hours to obtain an intermediate polyester B-1.

Then, the intermediate polyester B-1 and isophorone diisocyanate (IPDI) were charged at a molar ratio (IPDI isocyanate group/intermediate polyester hydroxyl group) of 1.8 into a reaction container equipped with a cooling tube, a stirrer, and a nitrogen introduction tube. Ethyl acetate solution was diluted with ethyl acetate to be 48% of ethyl acetate and reacted at 100° C. for 5 hours to obtain a nonlinear polyester resin B (prepolymer B) having a reactive group.

Tg of the prepolymer B was −38.5° C., Mw was 12,000, and acid number was 0.14.

### Manufacturing Example C-1: Synthesis of Crystalline Polyester Resin C-1

Sebacic acid and 1,6-hexanediol were charged into a 5 L four-neck flask equipped with a nitrogen introduction tube, a dewatering tube, a stirrer, and a thermocouple so that the molar ratio (OH/COOH) of the OH group to the COOH group was set to be 1.1. The reaction was carried out with 500 ppm titanium tetraisopropoxide with respect to the mass of the raw materials while allowing water to evaporate, and finally the temperature was raised to 235° C. for 1 hour.

The reaction was then carried out under reduced pressure below 10 mmHg for 6 hours. Thereafter, the temperature was set to 185° C., anhydrous trimellitic acid was added so that the molar ratio of anhydrous trimellitic acid to COOH group was 0.053 and reacted for 2 hours with stirring to obtain a crystalline polyester resin C-1 was obtained.

The resulting resin had an acid value (AV) of 18 mg KOH/g, a melting point (Tm) of 67° C., and a weight-average molecular weight of 10,500.

<Testing Compatibility of Crystalline Polyester Resin and Amorphous Polyester Resin>

The compatibility of the crystalline polyester resin C-1 with amorphous polyester resin A-1 was tested. That is, the endothermic value ΔHA (J/g) was determined when 90 parts of amorphous polyester resin A-1 and 10 parts of crystalline polyester resin C-1 were mixed and the temperature was increased to 150° C. at a rate of 10° C. per minute in a DSC system. The compatibility was determined by dividing ΔHA by 10% of the endothermic value ΔHC of the crystalline polyester resin A-1.

Thus, compatibility of the crystalline polyester resin C-1 with the amorphous polyester resin was calculated from the equation of compatibility (%)=100·ΔHA/(ΔHC/10).

As a result, the compatibility of the crystalline polyester resin C-1 with the amorphous polyester resin A-1 was 91%. Similarly, the compatibility of the crystalline polyester resin C-1 with amorphous polyester resin A-2 was 75%. Similarly, the compatibility of the crystalline polyester resin C-1 with amorphous polyester resin A-3 was 35%.

### Manufacturing Example C-2: Synthesis of Crystalline Polyester Resin C-2

A crystalline Polyester Resin C-2 was synthesized in the same manner as the Manufacturing Example C-1, except that that the monomers of acid and alcohol were changed to dodecanedioic acid and 1,10-decanediol. The resulting resin had an acid value (AV) of 15 mg KOH/g, a melting point (Tm) of 78° C., and a weight-average molecular weight of 11,000.

The compatibility of the crystalline Polyester Resin C-2 with amorphous polyester resin A-1 was 25%, compatibility of the crystalline Polyester Resin C-2 with amorphous polyester resin A-2 was 15%, and compatibility of the crystalline Polyester Resin C-2 with amorphous polyester resin A-3 was 5%.

### Manufacturing Example EA-1: Preparation of Amorphous Polyester Resin Emulsion EA-1

350 parts of the amorphous polyester resin A-1 and 350 parts of methyl ethyl ketone were placed in a separable flask, and the mixture was thoroughly mixed at 25° C., dissolved, and 10 parts of a 10% aqueous ammonia solution were added to the mixture dropwise.

The heating temperature was lowered to 35° C., and the ion-exchange water was dropped using a liquid feed pump at a liquid feed rate of 8 g/min. After the liquid was uniformly turbid, the liquid feed rate was increased to 12 g/min, and the addition of ion-exchange water was stopped when the total amount of the liquid became 1400 parts. The solvent was then removed under reduced pressure to obtain an amorphous polyester resin emulsion EA-1.

The resulting amorphous polyester resin particles had a volume average particle size of 35 nm.

### Manufacturing Example EA-2: Preparation of Amorphous Polyester Resin Emulsion EA-2

An emulsion was obtained in the same manner as the amorphous polyester resin emulsion EA-1, before the solvent was removed.

The amount of ethyl acetate to be removed under reduced pressure while keeping the temperature at 30° C. was weighed with a cooling trap, and when the amount of methyl ethyl ketone in the slurry was evaporated 70% with respect to the initial amount, the removal of solvent was stopped and the amorphous polyester resin emulsion EA-2 was obtained.

### Manufacturing Example EA-3: Preparation of Amorphous Polyester Resin Emulsion EA-3

350 parts of the amorphous polyester resin A-2 and 350 parts of methyl ethyl ketone were placed in a separable flask, and the mixture was thoroughly mixed at 25° C., dissolved, and 15 parts of 10% aqueous ammonia solution were added dropwise. Other conditions were the same as in Manufacture Example EA-1, and an amorphous polyester resin emulsion EA-3 was obtained.

The resulting amorphous polyester resin particles had a volume average particle size of 28 nm.

<Manufacturing example EA-4: Preparation of Amorphous Polyester Resin Emulsion EA-4>

350 parts of the amorphous polyester resin A-2 and 350 parts of methyl ethyl ketone were placed in a separable flask, and the mixture was thoroughly mixed at 25° C., dissolved, and 30 parts of 10% aqueous ammonia solution were added dropwise. Other conditions were the same as in Manufacture Example EA-1, and an amorphous polyester resin emulsion EA-4 was obtained.

The resulting amorphous polyester resin particles had a volume average particle size of 22 nm.

### Manufacturing Example EC-1: Preparation of Crystalline Polyester Resin Emulsion EC-1

70 parts of the crystalline polyester resin C-1, 50 parts of methyl ethyl ketone, and 20 parts of isopropyl alcohol were placed in a separable flask, and the mixture was thoroughly mixed at 40° C. and dissolved. Then, 10 parts of 10% aqueous ammonia solution were added dropwise.

The heating temperature was lowered to 65° C., and the ion-exchange water was dropped using a liquid feed pump at a liquid feed rate of 8 g/min. After the liquid was uniformly turbid, the liquid feed rate was increased to 12 g/min, and the addition of ion-exchange water was stopped when the total amount of the liquid became 1400 parts. The solvent was then removed under reduced pressure to obtain a crystalline polyester resin emulsion EC-1.

The resulting crystalline polyester resin particles had a volume average particle size of 8 nm. The resulting emulsion was heated to dry at 150° C. for 1 hour to determine the solid content.

### Manufacturing Examples EC-2 to EC-7: Preparation of Crystalline Polyester Resin Emulsions EC-2 to EC-7

The manufacturing conditions were varied as indicated in Table 1 below to prepare crystalline polyester resin emulsions. Other conditions were the same as those in Manufacturing Example EA-1.

TABLE 1

| Crystalline polyester | | | | | | |
|---|---|---|---|---|---|---|
| resin emulsion | EC-2 | EC-3 | EC-4 | EC-5 | EC-6 | EC-7 |
| Amount of crystalline | 105 | 140 | 175 | 210 | 210 | 210 |
| polyester resin | | | | | | |
| Amount of methyl | 75 | 100 | 125 | 150 | 150 | 150 |
| ethyl ketone | | | | | | |
| Amount of isopropyl | 30 | 40 | 50 | 60 | 60 | 60 |
| alcohol | | | | | | |
| Amount of aqueous | 6.3 | 5.6 | 3.5 | 2.1 | 1.7 | 1.3 |
| ammonia solution | | | | | | |
| Resulting | 11 | 32 | 150 | 290 | 490 | 600 |
| particle size | | | | | | |

### Manufacturing Example EC-8: Preparation of Crystalline Polyester Resin Emulsion EC-8

175 parts of the crystalline polyester resin C-2, 125 parts of methyl ethyl ketone, and 50 parts of isopropyl alcohol were placed in a separable flask, and the mixture was thoroughly mixed at 50° C. and dissolved. Then, 3.0 parts of 10% aqueous ammonia solution were added dropwise.

The heating temperature was lowered to 75° C., and the ion-exchange water was dropped using a liquid feed pump at a liquid feed rate of 8 g/min. After the liquid was uniformly turbid, the liquid feed rate was increased to 12 g/min, and the addition of ion-exchange water was stopped when the total amount of the liquid became 1400 parts. The solvent was then removed under reduced pressure to obtain a crystalline polyester resin emulsion EC-8.

The resulting crystalline polyester resin particles had a volume average particle size of 140 nm. The resulting emulsion was heated to dry at 150° C. for 1 hour to determine the solid content.

### Manufacturing Example DC-1: Preparation of Crystalline Polyester Resin Dispersion Liquid DC-1

45 parts of the crystalline polyester resin C-1 and 450 parts of ethyl acetate were charged into a container with a stir bar and thermometer set, and the temperature was raised to 80° C. under stirring and kept at 80° C. for 5 hours.

Thereafter, the mixture was cooled to 30° C. in 1 hour, a dispersion was performed with use of a bead mill (Ultravisco Mill, manufactured by IMEX Co., Ltd.) at a liquid feeding rate of 1 kg/hr, at a disk circumferential speed of 6 m/sec, and at a filling rate of 80% by volume of 0.5 mm zirconia beads, under three passes to obtain a crystalline polyester resin dispersion liquid DC-1.

The resulting crystalline polyester resin particles had the volume average particle size of 350 nm, and the concentration of solid content of the resin particles was 10%.

Hereinafter, Examples and Comparative Examples will be described.

### Example 1

<Adjustment of Master Batch (MB)>

600 parts of water, 500 parts of carbon black (Nipex 60, manufactured by Degussa AG), and 500 parts of the amorphous polyester resin A-1 were added and mixed with a Henschel mixer (manufactured by Mitsui Mining Co., Ltd.). The mixture was kneaded with two rollers at 150° C. for 30 minutes. After cooling by press-rolling the mixture, the mixture was pulverized by a pulverizer to obtain a master batch 1.

<Preparation of WAX Dispersion Liquid 1>

42 parts of Carnauba wax (RN-5, vegetable wax, melting point 82° C., manufactured by CERARICA NODA Co., Ltd.) and 420 parts of ethyl acetate were charged into a container equipped with a stir bar and a thermometer, and the temperature was raised to 80° C. with stirring. The temperature was raised to 80° C. under stirring and maintained at 80° C. for 5 hours.

Thereafter, the mixture was cooled to 30° C. in 1 hour, a dispersion was performed with use of a bead mill (Ultravisco Mill, manufactured by IMEX Co., Ltd.) at a liquid feeding rate of 1 kg/hr, at a disk circumferential speed of 6 m/sec, and at a filling rate of 80% by volume of 0.5 mm zirconia beads, under three passes to obtain a WAX dispersion liquid 1.

The resulting wax particles had the volume average particle size of 420 nm, and the concentration of solid content of the resulting wax particles was 10%.

<Preparation of Oil Phase>

250 parts of the WAX dispersion liquid 1, 250 parts of the amorphous polyester resin A-1, 50 parts of the master batch 1, and 225 parts of ethyl acetate were placed in a container, and the internal temperature was maintained at 25° C. with a TK homomixer (manufactured by Tokusyu Kiki) and mixed and dispersed at 5,000 rpm for 1 hour to obtain an oil phase 1.

<Preparation of Aqueous Phase>

990 parts of water, 20 parts of sodium dodecyl sulfate, and 90 parts of ethyl acetate were mixed and stirred to obtain an opalescent liquid. This was designated as an aqueous phase 1.

<Phase Inversion Emulsification>

700 parts of the oil phase 1 was stirred with a TK homomixer at 8,000 rpm while adding 20 parts of 28% aqueous ammonia solution, followed by mixing the mixture for 10 minutes. The water phase 1 was gradually dropped to obtain an emulsion slurry 1.

<Removal of Solvent>

The emulsion slurry 1 was charged into a container equipped with a stirrer and a thermometer. The amount of ethyl acetate to be removed under reduced pressure while keeping the temperature at 30° C. was weighed with a cooling trap, and when the amount of ethyl acetate in the oil phase 1 was evaporated 80% with respect to the initial amount, the removal of solvent was stopped and a solvent-containing slurry 1 was obtained.

<Agglomeration>

35 parts in terms of solid content of the crystalline polyester resin emulsion EC-2 was added to the solvent-containing slurry 1, and the mixture was stirred and mixed evenly with a Three-one motor having a paddle agitator blade. While stirring the mixture at 300 rpm, 200 parts by weight of a 35 magnesium chloride solution was added dropwise to the mixture over 30 minutes and stirred for 5 minutes. The temperature was then raised to 50° C. When the particle size became 5.0 μm, the stirring temperature was maintained for 1 hour.

<Forming Shell>

Furthermore, 200 parts of the amorphous polyester resin emulsion EA-1 was added to the mixture while stirring the mixture at 300 rpm at 50° C., and then 100 parts by weight of a 3% magnesium chloride solution was added to the mixture dropwise over 30 minutes. In addition, 50 parts by weight of sodium chloride was added to the mixture, and the mixture was stirred with heating for 1 hour.

After agglomeration of the toner particles and formation of shell were completed, the mixture was cooled. The remaining solvent was completely removed from the mixture by depressurization to obtain a dispersion slurry 1 in which an average circularity of the toner particle was 0.957.

Although, heat lower than Tg of the crystalline or amorphous polyester resins was applied, by leaving some solvent, agglomerating, and adjusting the temperature of forming shell at 50° C., the residual ethyl acetate allowed the fusion of the toner to proceed and produce a shell toner with the desired circularity.

<Washing and Drying>

100 parts of the dispersion slurry 1 was filtered under reduced pressure. The following steps (1) to (4) were repeated twice to obtain a filtered cake 1.

(1) 100 parts of ion-exchanged water was added to the filter cake, mixed with a TK homomixer at 12,000 rpm for 10 minutes, and then filtered.

(2) 100 parts of a 10% sodium hydroxide solution was added to the filter cake obtained from the above (1), mixed with a TK homomixer at 12,000 rpm for 30 minutes, and then filtered under reduced pressure.

(3) 100 parts of 10% hydrochloric acid was added to the filter cake obtained from the above (2), mixed with a TK homomixer at 12,000 rpm for 10 minutes, and then filtered.

(4) 300 parts of ion-exchanged water was added to the filter cake obtained from the above (3), mixed with a TK homomixer at 12000 rpm for 10 minutes, and then filtered.

The filtered cake 1 was dried at 45° C. for 48 hours using a recirculating air dryer, and then screened with a mesh with an eye opening of 75 μm to obtain the base particle 1.

<External Additive Treatment Step>

100 parts of the toner base particles 1 was mixed with 2.0 parts of hydrophobic silica (HDK-2000, manufactured by Clariant Co., Ltd.) as an external additive with a Henschel mixer, and the mixture was passed through a 500-mesh screen to obtain toner 1. The conditions are indicated in Table 2.

### Example 2

Example 2 was performed in the same manner as Example 1 to obtain toner 2, except that the crystalline polyester resin emulsion EC-2 to be added in the agglomeration step in Example 1 was changed to the crystalline polyester resin emulsion EC-3. The conditions are indicated in Table 2.

### Example 3

Example 3 was performed in the same manner as Example 1 to obtain toner 3, except that the crystalline polyester resin emulsion EC-2 to be added in the agglomeration step in Example 1 was changed to the crystalline polyester resin emulsion EC-5. The conditions are indicated in Table 2.

### Example 4

Example 4 was performed in the same manner as Example 1 to obtain toner 4, except that the crystalline polyester resin emulsion EC-2 to be added in the agglomeration step in Example 1 was changed to the crystalline polyester resin emulsion EC-6. The conditions are indicated in Table 2.

### Example 5

Example 5 was performed in the same manner as Example 1 to obtain toner 5, except that the crystalline polyester resin emulsion EC-2 to be added in the agglomeration step in Example 1 was changed to the crystalline polyester resin emulsion EC-4, and the temperature of the shell formation step was changed from 50° C. to 55° C. The conditions are indicated in Table 2.

### Example 6

The same procedure was applied to obtain toner 6, except that the temperatures of the agglomeration step and shell formation step in Example 5 were changed from 50° C. to 60° C. The conditions are indicated in Table 2.

### Example 7

Example 7 was performed in the same manner as in Example 5 to obtain toner 7, except that the temperature of the agglomeration and shell formation step in Example 5 was changed from 50° C. to 65° C. The conditions are indicated in Table 3.

### Example 8

Example 8 was performed in the same manner as in Example 1 to obtain toner 8, except that the crystalline polyester resin emulsion EC-2 to be added in the agglomeration step in Example 1 was changed to the crystalline polyester resin emulsion EC-4. The conditions are indicated in Table 3.

### Example 9

Examples 9 was performed in the same manner as in Example 1 until the agglomeration step. Before the shell formation step, ethyl acetate was completely evaporated and removed from the system, and cooled to 20° C. The conditions are indicated in Table 3.

<Shell Formation>

200 parts of the amorphous polyester resin emulsion EA-2 was added to the resulting slurry over 30 minutes while stirring at 300 rpm, and then 100 parts by weight of a 35 magnesium chloride solution was added dropwise over 30 minutes.

In addition, 50 parts by weight of sodium chloride was added to the mixture and stirred at 50° C. for 1 hour. The mixture was then cooled to room temperature and the remaining solvent was evaporated completely under reduced pressure. Thereafter, toner 9 was obtained in the same manner as Example 1. The conditions are indicated in Table 3.

### Example 10

Example 10 was performed in the same manner as in Example 1 to obtain toner 10, except that the emulsion used in the shell formation step in Example 1 was changed to the amorphous polyester resin emulsion EA-4. The conditions are indicated in Table 3.

### Example 11

Example 11 was performed in the same manner as in Example 1 to obtain toner 11, except that the crystalline polyester resin emulsion EC-2 to be added in the agglomeration step in Example 1 was changed to the crystalline polyester resin emulsion EC-8. The conditions are indicated in Table 3.

### Example 12

In the preparation of oil phase of Example 8, 250 parts of the WAX dispersion liquid 1, 200 parts of the amorphous polyester resin A-1, 100 parts of the prepolymer B, 50 parts of the master batch 1, and 175 parts of ethyl acetate were placed in a container. The internal temperature of the container was maintained at 25° C. with a TK homomixer (manufactured by Tokusyu Kiki) and mixed and dispersed at 5,000 rpm for 1 hour to obtain oil phase 12.

<Preparation of Aqueous Phase>

990 parts of water, 20 parts of sodium dodecyl sulfate, and 90 parts of ethyl acetate were mixed and stirred to obtain an opalescent liquid. This was designated as aqueous phase 12.

<Phase Inversion Emulsification>

20 parts of 28% ammonia water was added to 700 parts of oil phase 12 while stirring the mixture with a TK homomixer at 8,000 rpm for 10 minutes, and then aqueous phase 1 was gradually dropped to the mixture to obtain emulsion slurry 12. 30 parts of a 10% aqueous solution of isophorone diamine was added to the resulting emulsion slurry 12, and the mixture was stirred and mixed at room temperature for 1 hour. Thereafter, agglomeration step, shell formation, cleaning, drying, and external addition treatment were performed in the same manner as in Example 8 to obtain toner 12. The conditions are indicated in Table 3.

### Comparative Example 1

Comparative Example 1 was performed in the same manner as in Example 1 to obtain comparative toner 1, except that the crystalline polyester resin emulsion EC-2 to be added in the agglomeration step in Example 1 was changed to the crystalline polyester resin emulsion EC-1. The conditions are indicated in Table 4.

### Comparative Example 2

Comparative Example 2 was performed in the same manner as in Example 1 to obtain comparative toner 2, except that the crystalline polyester resin emulsion EC-2 to be added in the agglomeration step in Example 1 was changed to the crystalline polyester resin emulsion EC-7. The conditions are indicated in Table 4.

### Comparative Example 3

Comparative Example 3 was performed in the same manner as in Example 1 to obtain comparative toner 3, except that the temperatures in the agglomeration step and the shell formation step in Example 1 was changed from 50° C. to 70° C. The conditions are indicated in Table 4.

### Comparative Example 4

An adjustment of master batch (MB) and a preparation of WAX dispersion liquid 1 were performed in the same manner as in Example 1.

<Preparation of Oil Phase>

250 parts of the WAX dispersion liquid 1, 250 parts of the amorphous polyester resin A-1, 50 parts of the master batch 1, and 350 parts of the crystalline polyester resin dispersion liquid DC-1 were placed in a container, and the internal temperature was maintained at 25° C. with a TK homomixer (manufactured by Tokusyu Kiki) and mixed and dispersed at 5,000 rpm for 1 hour to obtain a comparative oil phase 4.

<Preparation of Aqueous Phase>

990 parts of water, 20 parts of sodium dodecyl sulfate, and 90 parts of ethyl acetate were mixed and stirred to obtain an opalescent liquid. This was designated as aqueous phase 4.

<Phase Inversion Emulsification>

20 parts of 281 ammonia water was added to 700 parts of comparative oil phase 4 while stirring the mixture with a TK homomixer at 8,000 rpm for 10 minutes, and then aqueous phase 4 was gradually dropped to the mixture to obtain comparative emulsion slurry 4.

<Removal of Solvent>

The comparative emulsion slurry 4 was charged into a container equipped with a stirrer and a thermometer. Ethyl acetate was completely evaporated and removed from the system under reduced pressure while keeping the temperature at 30° C. to obtain a comparative desolvated slurry 4.

<Agglomeration>

200 parts by weight of a 3% magnesium chloride solution was added to the comparative desolvated slurry 4 dropwise over 30 minutes while stirring the mixture at 300 rpm, and the mixture was further stirred for 5 minutes. Thereafter, the temperature of the mixture was raised to 80° C. When the particle size became 5.0 μm, the stirring temperature was maintained for 1 hour.

<Shell Formation>

Furthermore, 200 parts of the amorphous polyester resin emulsion EA-1 was added to the mixture over 30 minutes while stirring the mixture at 300 rpm at 80° C., and then 100 parts by weight of a 3% magnesium chloride solution was added to the mixture dropwise over 30 minutes. In addition, 50 parts by weight of sodium chloride was added to the mixture, and the mixture was heat-stirred in the system at 90° C. for 1 hour. Thereafter, the system was cooled to 65° C. and maintained for 3 hours for annealing.

After the completion of agglomeration, shell formation, and annealing, the mixture was cooled to obtain comparative dispersion slurry 4 with an average circularity of 0.960. Thereafter, the same step was performed as in Example 1 to obtain comparative toner 4. The conditions are indicated in Table 4.

### Comparative Example 5

Comparative Example 5 was performed in the same manner as in Example 1 until the phase inversion emulsification step.

<Removal of Solvent>

The emulsion slurry was charged into a container equipped with a stirrer and thermometer, and ethyl acetate was evaporated and removed under reduced pressure while keeping at 30° C.

<Agglomeration>

35 parts in terms of solid content of the crystalline polyester resin emulsion EC-4 was added to the desolvated slurry, and the mixture was stirred and mixed evenly with a Three one motor having a paddle agitator blade. While stirring the mixture at 300 rpm, 200 parts by weight of a 3% magnesium chloride solution was added dropwise to the mixture over 30 minutes and further stirred for 5 minutes. The temperature was then raised to 70° C. When the particle size became 5.0 μm, the temperature was raised to 80° C., and the stirring temperature was maintained for 1 hour.

<Shell Formation>

Furthermore, 200 parts of the amorphous polyester resin emulsion EA-4 was added to the mixture over 30 minutes while stirring the mixture at 300 rpm at 80° C., and then 100 parts by weight of a 3% magnesium chloride solution was added to the mixture dropwise over 30 minutes. In addition, 50 parts by weight of sodium chloride was added to the mixture, and the mixture was heat-stirred in the system at 90° C. for 1 hour. Thereafter, the system was cooled to 65° C. and maintained for 3 hours for annealing.

After the completion of agglomeration, shell formation, and annealing, the mixture was cooled to obtain comparative dispersion slurry 5 with an average circularity of 0.962. Thereafter, the same steps were performed as in Example 1 to obtain comparative toner 5. The conditions are indicated in Table 4.

<Evaluation of Toner Characteristics>

Each toner or developer was used to evaluate various characteristics as follows. The results are indicated in Tables 2 to 4.

<Low Temperature Fixing Property>

After each developer was injected into a unit of a color multifunctional printer (Imagio, MP C4300, manufactured by Ricoh Co., Ltd.), a solid rectangular image of 2 cm×15 cm was formed on a PPC paper (Ricoh, type 6000<70W>A4, grain long paper) so that the stuck toner amount was 0.40 mg/cm².

At this time, the surface temperature of the fixing roller was changed, and it was observed whether or not an offset in which the developing residual image of the solid image is fixed to a place other than a desired place was generated, and the low temperature fixing property was evaluated based on the following criteria. If the evaluation results are “3” or more, it is practically a usable level.

[Evaluation Criteria for Low Temperature Fixing Property]
5: below 100° C.
4: 100° C. or higher to less than 120° C.
3: 110° C. or higher, less than 120° C.
2: 120° C. or higher, less than 130° C.
1: 130° C. or higher

<Heat Resistant Preservability>

Each toner was filled into a 50-mL glass container, left in a thermostatic bath at 50° C. for 24 hours, and then cooled to 24° C. Next, the degree of needle penetration [mm] was measured by the needle penetration test (JIS K2235-1991), and the heat resistant preservability was evaluated based on the following criteria. An evaluation result of “3” or higher indicates that the product can be used in practical applications.

[Evaluation Criteria for Heat Resistant Preservability]
5: Needle was completely penetrated.
4: The degree of needle penetration was 20 mm or more.
3: The degree of needle penetration was within a range from 15 mm to less than 20 mm.
2: The degree of needle penetration was within a range from 10 mm to less than 15 mm.
1: The degree of needle penetration was less than 10 mm.

<Image Quality (Transferability)>

A color production printer (RICOH Pro C7210S, manufactured by Ricoh Co., Ltd.) was used to form a 400 dpi standard line chart image (output image) on a coated paper (POD gloss coated paper, manufactured by Oji Paper Co., Ltd). The output image was formed so that a line image of a black solid image was generated.

The formed thin line portion was compared to the image of the document file, and reproducibility was evaluated according to the following table. An evaluation result of “3” or higher indicates that the product can be used in practical applications.

[Evaluation Standards]
5: Continuous line image of the original image is reproduced without any missing parts of the high-brightness lines, even when observed with a loupe.
4: Slight partial missing parts of the line image can be seen when observed with a loupe at 100× magnification.
3: Partial missing parts of the line image can be seen when observed with a loupe at 100× magnification.
2: Partial missing parts of the line image can be seen visually.
1: Continuous missing parts of the line image are clearly visible.

TABLE 2

| Characteristics/ | Examples | | | | | |
|---|---|---|---|---|---|---|
| Evaluation Criteria | 1 | 2 | 3 | 4 | 5 | 6 |
| Crystalline polyester | EC-2 | EC-3 | EC-5 | EC-6 | EC-4 | EC-4 |
| resin emulsion | | | | | | |
| Maximum heating | 50° C. | 50° C. | 50° C. | 50° C. | 55° C. | 60° C. |
| temperature | | | | | | |
| Longitudinal diameter | 12 | 35 | 280 | 495 | 145 | 110 |
| of crystalline | | | | | | |
| polyester resin | | | | | | |
| Aspect ratio | 1.15 | 1.16 | 1.2 | 1.35 | 1.8 | 2.1 |
| Presence of lamellar | Present | Present | Present | Present | Present | Present |
| structure | | | | | | |
| Acid value | Same as | Same as | Same as | Same as | Same as | Same as |
| of shell | core | core | core | core | core | core |
| Low temperature | 5 | 4 | 3 | 3 | 4 | 4 |
| fixing property | | | | | | |
| Heat resistant | 3 | 3 | 4 | 4 | 4 | 3 |
| preservability | | | | | | |
| Transferability | 3 | 4 | 4 | 3 | 4 | 3 |

TABLE 3

| Characteristics/ | Examples | | | | | |
|---|---|---|---|---|---|---|
| Evaluation Criteria | 7 | 8 | 9 | 10 | 11 | 12 |
| Crystalline polyester | EC-4 | EC-4 | EC-4 | EC-4 | EC-8 | EC-4 |
| resin emulsion | | | | | | |
| Maximum heating | 65° C. | 50° C. | 50° C. | 50° C. | 50° C. | 50° C. |
| temperature | | | | | | |
| Longitudinal diameter | 95 | 150 | 150 | 150 | 135 | 145 |
| of crystalline | | | | | | |
| polyester resin | | | | | | |
| Aspect ratio | 2.9 | 1.16 | 1.16 | 1.16 | 1.13 | 1.15 |
| Presence of lamellar | Present | Present | Absent | Absent | Absent | Present |
| structure | | | | | | |
| Acid value | Same as | Same as | Same as | Greater | Same as | Same as |
| of shell | core | core | core | than that | core | core |
| | | | | of core | | |
| Low temperature | 4 | 4 | 4 | 3 | 3 | 5 |
| fixing property | | | | | | |
| Heat resistant | 3 | 4 | 5 | 5 | 5 | 5 |
| preservability | | | | | | |
| Transferability | 3 | 4 | 4 | 5 | 5 | 5 |

TABLE 4

| Characteristics/ | Comparative Examples | | | | |
|---|---|---|---|---|---|
| Evaluation Criteria | 1 | 2 | 3 | 4 | 5 |
| Crystalline polyester | EC-1 | EC-7 | EC-2 | DC-1 | EC-4 |
| resin emulsion | | | | | |
| Maximum heating | 50° C. | 50° C. | 70° C. | 90° C. | 90° C. |
| temperature | | | | | |
| Longitudinal diameter | 9 | 580 | 125 | 600 | 500 |
| of crystalline | | | | | |
| polyester resin | | | | | |
| Aspect ratio | 1.15 | 1.21 | 3.5 | 8 | 12 |
| Presence of lamellar | Present | Present | Present | Present | Present |
| structure | | | | | |
| Acid value | Same as | Same as | Same as | Same as | Higher |
| of shell | core | core | core | core | than core |
| Low temperature | 4 | 1 | 3 | 2 | 2 |
| fixing property | | | | | |
| Heat resistant | 1 | 3 | 2 | 1 | 1 |
| preservability | | | | | |
| Transferability | 1 | 2 | 1 | 1 | 1 |

As described above, in Examples 1 to 12, toner having excellent low temperature fixing property, heat resistant preservability, and excellent image quality (transferability) was obtained.

On the other hand, in Comparative Examples 1 to 5, toner, that was compatible with low temperature fixing property, heat resistant preservability, and image quality (transferability), was not obtained.

The embodiments of the present invention are, for examples, as follows.

(1) A toner includes: a core including a crystalline polyester; and a shell formed on a surface of the core, wherein an aspect ratio of the crystalline polyester in the toner is within a range from 1 to 3, and wherein an average length of a longitudinal diameter of the crystalline polyester is within a range from 10 nm to 500 nm.

(2) In the toner according to the above (1), the aspect ratio is within a range from 1 to 2.

(3) In the toner according to the above (1) or (2), the average length of the longitudinal diameter of the crystalline polyester is within a range from 30 nm to 300 nm.

(4) In the toner according to any one of the above (1) to (3), a lamellar structure of the crystalline polyester is absent within 50 nm of a surface layer of the shell.

(5) In the toner according to any one of the above (1) to (4), an acid value of a resin constituting the shell is greater than an acid value of a resin constituting the core excluding the crystalline polyester.

(6) A method of manufacturing the toner according to any one of the above (1) to (5), includes: preparing an oil phase by dissolving or dispersing at least a resin and a mold release agent in an organic solvent; adding an aqueous medium to the oil phase to cause a phase inversion from a W/O emulsion to an O/W emulsion; and adding a crystalline polyester dispersion liquid to the O/W emulsion.

(7) The method of manufacturing the toner of the above (6), further includes: adding a pigment to the oil phase.

(8) The method of manufacturing the toner of the above (6) or (7), further includes: heating toner particles at a lower temperature of either a melting temperature of a crystalline polyester resin or a temperature of a glass transition point of the resulting toner.

(9) The method of manufacturing the toner of any one of the above (6) to (8), further includes: adding a prepolymer to the W/O emulsion.

(10) A toner storage unit is a storage unit in which the toner of any one of the above (1) to (5) is stored in the toner storage unit.

(11) An image forming apparatus includes: an electrostatic latent image carrier; an electrostatic latent image formation unit that forms an electrostatic latent image on the electrostatic latent image carrier; a developing unit that develops the electrostatic latent image formed on the electrostatic latent image carrier using the toner of any one of the above (1) to (5) to form a toner image; a transfer unit that transfers the toner image to a recording medium; and a fixing unit that fixes the transfer image transferred on a surface of the recording medium.

(12) A method of forming an image includes: forming an electrostatic latent image on an electrostatic latent image carrier; developing the electrostatic latent image formed on the electrostatic latent image carrier using the toner of any one of the above (1) to (5) to form a toner image; transferring the toner image formed on the electrostatic latent image carrier to a recording medium; and fixing the toner image transferred to the recording medium.

Although the embodiments of the invention have been described above, the invention is not limited to the specific embodiments, and various variations and changes are possible within the scope of the invention as described in the claims.

What is claimed is:

1. A toner comprising:
a core including a crystalline polyester; and
a shell formed on a surface of the core,
wherein an aspect ratio of the crystalline polyester in the toner is within a range from 1 to 3, and
wherein an average length of a longitudinal diameter of the crystalline polyester is within a range from 10 nm to 500 nm.

2. The toner according to claim 1, wherein the aspect ratio is within a range from 1 to 2.

3. The toner according to claim 1, wherein the average length of the longitudinal diameter of the crystalline polyester is within a range from 30 nm to 300 nm.

4. The toner according to claim 1, wherein a lamellar structure of the crystalline polyester is absent within 50 nm of a surface layer of the shell.

5. The toner according to claim 1, wherein an acid value of a resin constituting the shell is greater than an acid value of a resin constituting the core excluding the crystalline polyester.

6. A method of manufacturing the toner of claim 1 comprising:
preparing an oil phase by dissolving or dispersing at least a resin and a mold release agent in an organic solvent;
adding an aqueous medium to the oil phase to cause a phase inversion from a W/O emulsion to an O/W emulsion; and
adding a crystalline polyester dispersion liquid to the O/W emulsion.

7. The method of manufacturing the toner of claim 6, further comprising:
adding a pigment to the oil phase.

8. The method of manufacturing the toner of claim 6, further comprising:
heating toner particles at a lower temperature of either a melting temperature of a crystalline polyester resin or a temperature of a glass transition point of the resulting toner.

9. The method of manufacturing the toner of claim 6, further comprising:
adding a prepolymer to the W/O emulsion.

10. A toner storage unit, wherein the toner of claim 1 is stored in the toner storage unit.

11. An image forming apparatus comprising:
an electrostatic latent image carrier;
an electrostatic latent image formation unit that forms an electrostatic latent image on the electrostatic latent image carrier;
a developing unit that develops the electrostatic latent image formed on the electrostatic latent image carrier using the toner of claim 1 to form a toner image;
a transfer unit that transfers the toner image to a recording medium; and
a fixing unit that fixes the transfer image transferred on a surface of the recording medium.

12. A method of forming an image comprising:
forming an electrostatic latent image on an electrostatic latent image carrier;
developing the electrostatic latent image formed on the electrostatic latent image carrier using the toner of claim 1 to form a toner image;
transferring the toner image formed on the electrostatic latent image carrier to a recording medium; and
fixing the toner image transferred to the recording medium.
